(19) United States
(12) Patent Application Publication
(10) Pub. No.: US 2022/0317292 A1
(43) Pub. Date: Oct. 6, 2022

(54) DISTANCE MEASUREMENT DEVICE

(71) Applicant: Panasonic Intellectual Property Management Co., Ltd., Osaka (JP)

(72) Inventors: Yoshimasa OKABE, Kanagawa (JP); Toshimasa TAKAGI, Kanagawa (JP); Hiroki YAMASHITA, Kanagawa (JP)

(21) Appl. No.: 17/688,335

(22) Filed: Mar. 7, 2022

(30) Foreign Application Priority Data
Mar. 30, 2021 (JP) 2021-057656
Mar. 30, 2021 (JP) 2021-058639
Mar. 30, 2021 (JP) 2021-058713

(51) Int. Cl. G01S 15/32; G01S 15/931

(52) U.S. Cl. CPC G01S 15/32; G01S 15/931; G01S 2015/932

(57) ABSTRACT

A distance measurement device includes: a transmission and reception device configured to transmit a transmission wave and receive a reflected wave; a memory; and a hardware processor coupled to the memory. The hardware processor is configured to: detect a reception signal received by the transmission and reception device and obtain a reception waveform indicating a temporal change in an intensity of the reception signal; detect a feature amount of the reflected wave based on the reception waveform; calculate a distance from the distance measurement device to an object, based on the feature amount; and control a detection condition of detection of the feature amount by changing a threshold for detecting the feature amount, based on a change in the feature amount, in a case where the reflected wave arrives during a reverberation period in which reverberation of the transmission wave remains in the transmission and reception device.

### CROSS-REFERENCE TO RELATED APPLICATIONS

This application is based upon and claims the benefit of priority from Japanese Patent Applications No. 2021-057656, No. 2021-058639 and No. 2021-058713, filed on Mar. 30, 2021, the entire contents of all of which are incorporated herein by reference.

### FIELD

The present disclosure relates to a distance measurement device.

### BACKGROUND

There is an ultrasonic object detection device that detects a distance to an object based on a reflected wave of a transmission wave, then predicts the distance to the object at the time of next detection, and determines that the object is present within a range affected by reverberation of the transmission wave in a case where the predicted distance is equal to or less than an upper limit value of a distance by which the reflected wave from the object is returned while the reverberation occurs.

A conventional technique is described in JP 6387786 B2.

It is desirable to more appropriately measure a distance even in a range affected by reverberation.

The present disclosure has been made in view of the above, and an object of the present disclosure is to provide a distance measurement device capable of more appropriately measuring a distance even in a range affected by reverberation.

### SUMMARY

A distance measurement device according to the present disclosure is mountable on a vehicle. The distance measurement device includes a transmission and reception device, a memory, and a hardware processor coupled to the memory. The transmission and reception device is configured to transmit a transmission wave that is an ultrasonic wave and receive a reflected wave generated by the transmission wave. The hardware processor is configured to: detect a reception signal received by the transmission and reception device and obtain a reception waveform indicating a temporal change in an intensity of the reception signal; detect a feature amount of the reflected wave based on the reception waveform; calculate a distance from the distance measurement device to an object as a measurement distance, based on the feature amount; and control a detection condition of detection of the feature amount. The hardware processor is configured to adjust the detection condition by changing a threshold for detecting the feature amount, based on a change in the feature amount, in a case where the reflected wave arrives during a reverberation period in which reverberation of the transmission wave remains in the transmission and reception device.

### BRIEF DESCRIPTION OF THE DRAWINGS

FIG. 1 is a block diagram schematically illustrating an example of a configuration of a vehicle including a distance measurement device according to a first embodiment;

FIG. 2 is a diagram for describing reflection of an ultrasonic wave;

FIG. 3 is a reception waveform state diagram for describing a reception waveform;

FIG. 4 is a diagram illustrating an example of arrangement of sonars;

FIG. 5 is a diagram illustrating an example of a transmission interval of the ultrasonic wave;

FIG. 6 is a diagram illustrating an example of tracking;

FIG. 7 is a diagram illustrating an example of a functional configuration of the distance measurement device according to the first embodiment;

FIG. 8 is a graph illustrating an example of an amplitude of a vibration signal when the distance measurement device according to the first embodiment receives a reflected wave overlapping reverberation;

FIG. 9 is a graph illustrating an example of the amplitude of the vibration signal when the distance measurement device according to the first embodiment receives the reflected wave overlapping the reverberation;

FIG. 10 is a graph illustrating an example of the amplitude of the vibration signal when the distance measurement device according to the first embodiment receives the reflected wave overlapping the reverberation;

FIG. 11 is a graph illustrating an example of an amplitude of a vibration signal when the distance measurement device according to the first embodiment receives the reflected wave;

FIG. 12 is a flowchart illustrating an example of processing performed by the distance measurement device according to the first embodiment;

FIG. 13 is a diagram illustrating an example of a functional configuration of a distance measurement device according to a second embodiment;

FIG. 14 is a diagram for describing a method of specifying a reverberation curve;

FIG. 15 is a diagram for describing an example of adjusting a detection condition based on the reverberation curve;

FIG. 16 is a diagram illustrating a relationship between a saturation value and a reflected wave portion;

FIG. 17 is a diagram illustrating a relationship among the saturation value, a threshold, and the reverberation curve;

FIGS. 18A to 18D are diagrams for describing a time point for calculating a distance among reflected waves;

FIGS. 19A to 19C are diagrams for describing a method of specifying a peak position and a rising position;

FIGS. 20A to 20C are diagrams for describing processing in a case where the vicinity of a peak is saturated;

FIGS. 21A and 21B are diagrams for describing adjustment of an offset between the peak position and the rising position;

FIGS. 22A to 22C are diagrams for describing a method of estimating a rising point from a waveform of an upward slope of a reflected wave RW1;

FIGS. 23A to 23C are diagrams for describing a method of a dynamic control of a detection condition according to the reverberation curve;

FIGS. 24A to 24C are diagrams for describing a timing at which the reflected wave cannot be detected based on a predicted distance;

FIG. 25 is a flowchart for describing a processing procedure in which the distance measurement device according to the second embodiment measures the distance;

FIG. 26 is a diagram for describing an example of dynamically changing the threshold;

FIG. 27 is a diagram illustrating an example of an air attenuation curve;

FIGS. 28A to 28C are diagrams illustrating examples of a change mode of the threshold; and

FIG. 29 is a flowchart for describing a processing procedure in which a distance measurement device according to a third embodiment measures a distance.

### DETAILED DESCRIPTION

Hereinafter, an embodiment of a distance measurement device according to the present disclosure will be described with reference to the drawings.

### First Embodiment

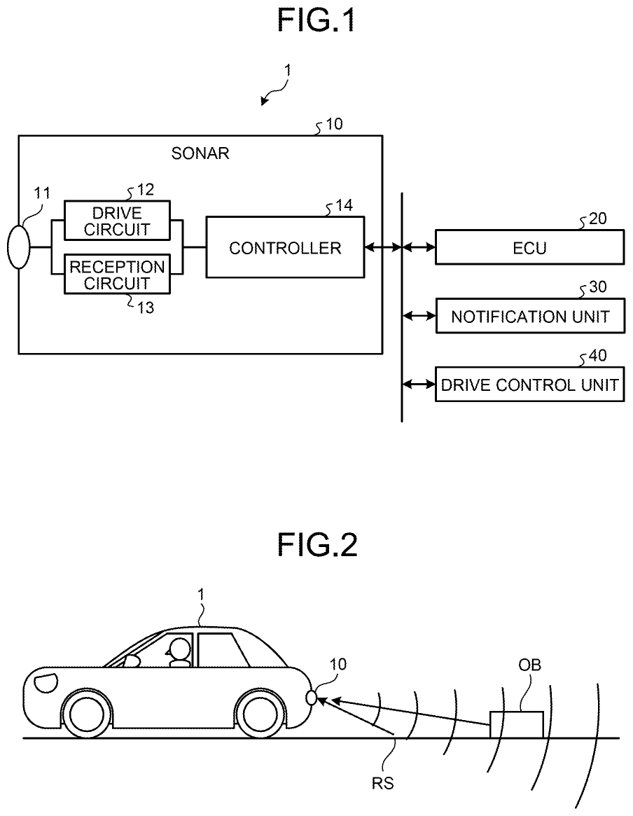

FIG. 1 is a block diagram schematically illustrating an example of a configuration of a vehicle including a distance measurement device according to a first embodiment.

A vehicle 1 includes a sonar 10, an electronic control unit (ECU) 20, a notification unit 30, and a drive control unit 40.

The ECU 20 is a control unit that controls the sonar 10 to detect a distance to an object around the vehicle 1, and controls an operation of the vehicle 1 according to a detection result. For example, when the ECU 20 specifies that an obstacle is positioned in a traveling direction of the vehicle 1 from distance information obtained from the sonar 10, the ECU 20 performs various controls such as braking of the vehicle 1. The ECU 20 also acquires information from various sensors other than the sonar 10. For example, the ECU 20 acquires speed information, direction information, and acceleration information from known sensors.

The notification unit 30 notifies that the obstacle has been detected. For example, the notification unit 30 is a device that performs display output or sound output.

The drive control unit 40 is a device that controls a motion of the vehicle 1, and is a device that controls a drive device such as a brake or an engine. The sonar 10, the notification unit 30, and the drive control unit 40 are connected to the ECU 20 in a wired manner via a LAN cable or the like, and an instruction to notify that the obstacle has been detected or an instruction to operate a brake is transmitted from the ECU 20 in a form of an electric control signal.

The sonar 10 includes a piezoelectric element 11, a drive circuit 12, a reception circuit 13, and a controller 14. The sonar 10 operates the drive circuit 12 under the control of the controller 14 to apply an alternating current (AC) voltage of 50 KHz to the piezoelectric element 11, and the piezoelectric element 11 deforms according to the AC voltage and transmits an ultrasonic wave of the same frequency. Since a period during which the AC voltage is applied is short, the sonar 10 transmits a pulsed ultrasonic wave.

As illustrated in FIG. 2, when the pulsed ultrasonic wave transmitted by the sonar 10 mounted on the vehicle 1 hits a road surface RS or an obstacle OB, the pulsed ultrasonic wave is reflected and partially returns to the piezoelectric element 11. Since the piezoelectric element 11 converts a pressure applied to a surface into a voltage, the piezoelectric element 11 outputs a voltage proportional to a sound pressure of a received sound. The received sound includes the reflected wave. As described above, since the piezoelectric element 11 transmits and receives the ultrasonic wave, the piezoelectric element 11 may be referred to as a transmission and reception unit (device). The reception circuit 13 amplifies the voltage output from the piezoelectric element 11 to obtain a reception signal, and transmits the reception signal to the controller 14.

The controller 14 acquires a reception waveform based on the reception signal. Here, the reception waveform is obtained by performing envelope detection on an AC sound wave waveform converted from the sound pressure to the voltage by the piezoelectric element 11 and converting the waveform into a sound wave reception intensity, and indicates a temporal change in intensity of the reception signal. A part of the controller 14 that converts the reception signal into the reception waveform may be referred to as a detection unit. The detection unit may be provided in the reception circuit 13. That is, the detection unit may amplify the voltage output from the reception circuit 13 and then perform envelope detection to acquire the reception waveform and output the reception waveform to the controller 14.

In a case where the ultrasonic wave transmitted by the sonar 10 hits the obstacle OB and are reflected, the farther the obstacle OB is, the longer the time taken by the reflected wave to return is. Therefore, in a case where it is possible to detect the reflected wave from the reception waveform and specify a reception time of the reflected wave, the distance can be calculated based on a time difference between a transmission time and the reception time. The ultrasonic wave is also reflected from the road surface RS. The reflected wave from the road surface is referred to as road surface reflection.

Since a reception intensity of the road surface reflection is lower than a reception intensity of the reflected wave from the obstacle OB, a curve that the reception intensity of the road surface reflection does not exceed is set in advance as a detection threshold, and it is determined that there is a reflected wave in a portion where the reception waveform exceeds the detection threshold, and it is determined that there is no reflected wave in a portion where the reception waveform is equal to or less than the detection threshold. Since the road surface reflection is not a detection target of the distance measurement device, the road surface reflection may be referred to as unnecessary reflection, or the road surface reflection may be regarded as included in noise without being distinguished from the noise. In general, the ultrasonic wave attenuates rapidly in the air, and thus, the reception intensity of the ultrasonic wave reflected from a more distant place is lower. Therefore, the detection threshold is set in such a manner that the longer the distance is, the smaller the detection threshold is. Hereinafter, for convenience, the detection threshold is referred to as a threshold.

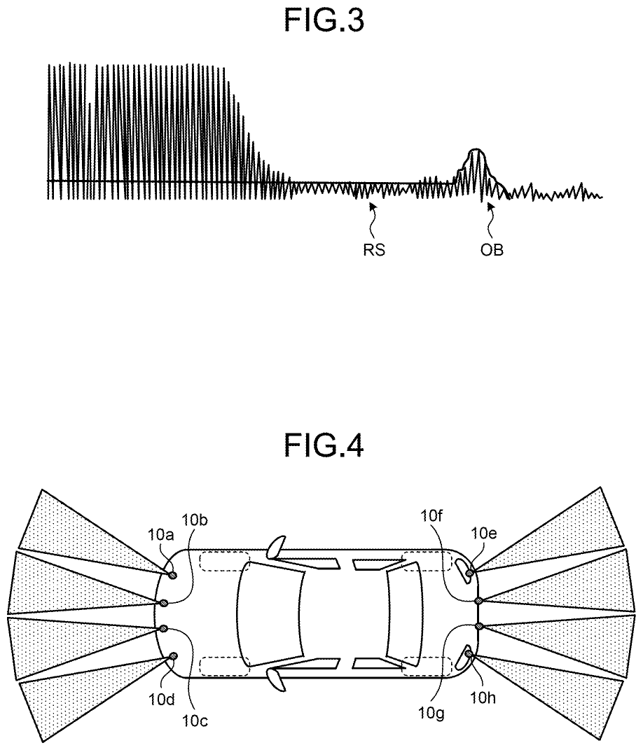

Here, FIG. 3 illustrates a reception waveform state diagram illustrating a temporal change in reflected wave in the reception waveform. The reflected wave includes an obstacle reflection portion OB and a road surface reflection portion RS. A line that envelops waveforms in the reflection portion OB and the road surface reflection portion RS is an envelope. As described above, the envelope is obtained by performing envelope detection on an AC sound wave waveform. The vehicle 1 can detect the reflected wave OB from the obstacle according to the determined threshold, and calculate the distance based on a time delay from the transmission to the reflection OB.

In FIG. 3, the left end is a time point at which the sonar transmits the ultrasonic wave, and a flat portion continues from the time point to a portion where the ultrasonic wave attenuates according to an attenuation curve. In the flat portion, the reception circuit is saturated by reverberation in which a transmitted vibration remains, and an amplitude is thus limited to a maximum value. In practice, it should be understood that there is a waveform that attenuates downward to the right, such as the attenuation curve extending to the upper-left side. There is a portion in the middle of the flat portion where the waveform seems to be recessed, but this is a recess generated when the AC sound wave waveform is sampled, and the waveform becomes flat when the envelope detection is performed. That is, the recess is irrelevant to a mode of the reverberation. The reverberation will be described later.

Note that the vehicle 1 may include one sonar 10, or may include a plurality of sonars 10 (sonars 10a to 10h) as illustrated in FIG. 4. As illustrated in FIG. 4, in a case where the vehicle 1 includes a plurality of sonars 10, detection ranges of adjacent sonars 10 may overlap.

In addition, the vehicle 1 illustrated in FIG. 4 detects an obstacle in a traveling direction when traveling straight by using the sonar 10b and the sonar 10c. In addition, the vehicle 1 detects an obstacle in a direction in which the vehicle 1 turns by using the sonar 10a and the sonar 10d. The sonars 10a and 10d that are positioned on the outer sides are also called corner sonars. When an obstacle enters the traveling direction from the side of the vehicle 1, the corner sonar first detects the obstacle.

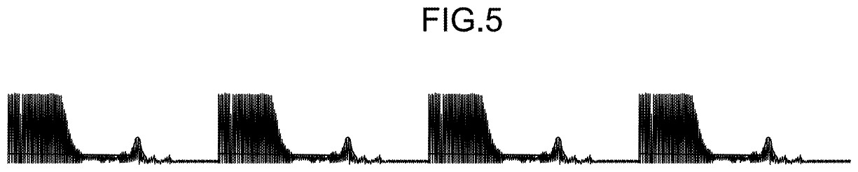

Further, in a case where a vehicle around the vehicle 1 also includes the sonar, the sonar 10 receives a reflected wave of an ultrasonic wave transmitted from another vehicle, and there is a possibility of erroneous detection. Therefore, as illustrated in FIG. 5, the sonar 10 determines that there is an obstacle in a case where the ultrasonic wave is transmitted at predetermined intervals and the reflected wave is received at the same timing continuously for a predetermined number of times. A timing at which the sonar 10 transmits the ultrasonic wave is a time point at which the flat portion described in FIG. 3 starts, that is, a time point at which the waveform rises to a saturation level in FIG. 5.

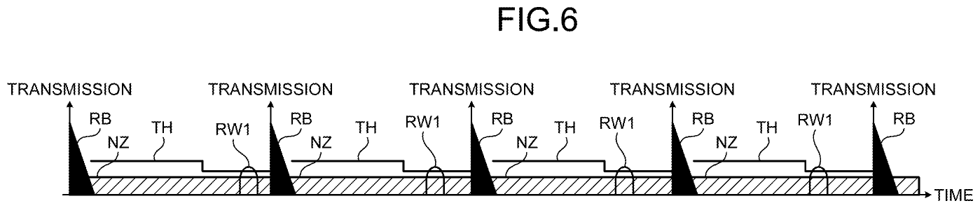

Next, detection and tracking of the obstacle will be described with reference to FIG. 6. FIG. 6 is a diagram schematically illustrating movement of a position of a reflected wave RW1 when the vehicle 1 approaches the obstacle. FIG. 6 illustrates a graph of the waveform illustrated in FIG. 5 flattened by compensating the attenuation of the reflected wave due to the distance.

When the reflected wave RW1 exceeds a predetermined obstacle threshold TH, the sonar 10 determines that there is an obstacle. Note that the obstacle threshold TH is desirably higher than a noise NZ. The noise NZ includes the road surface reflection. A time from a time point at which the ultrasonic wave is transmitted to a time point at which the reflected wave is detected is a flight time taken by the transmitted ultrasonic wave to be reflected by an object such as an obstacle and return. Therefore, the vehicle 1 can calculate the distance from the sonar 10 to the object by dividing the flight time by a sound speed to half.

In addition, as illustrated in FIG. 6, the vehicle 1 repeats object detection and calculates the distance each time to perform processing called tracking for tracking a change in distance information. For example, the vehicle 1 calculates a speed at which the distance to the object decreases, that is, an approaching speed, by the tracking, and can determine that the object is not moving and is a stationary object in a case where a vehicle speed and the approaching speed match within an error range.

In addition, the vehicle 1 can specify coordinate information of the object by processing FT when a sound wave reflected by one object is received by a plurality of sonars based on the principle of trilateration. The tracking also includes tracking on the coordinates.

Further, the piezoelectric element 11 of the sonar 10 continues to vibrate even after the transmission, that is, the application of the AC voltage is stopped. The vibration after the application of the AC voltage is stopped is reverberation RB illustrated in FIG. 6. This reverberation RB gradually attenuates according to an exponential curve. The distance measurement device according to the present embodiment appropriately calculates the distance even in a range affected by the reverberation RB.

Functional Configuration Diagram of Distance Measurement Device

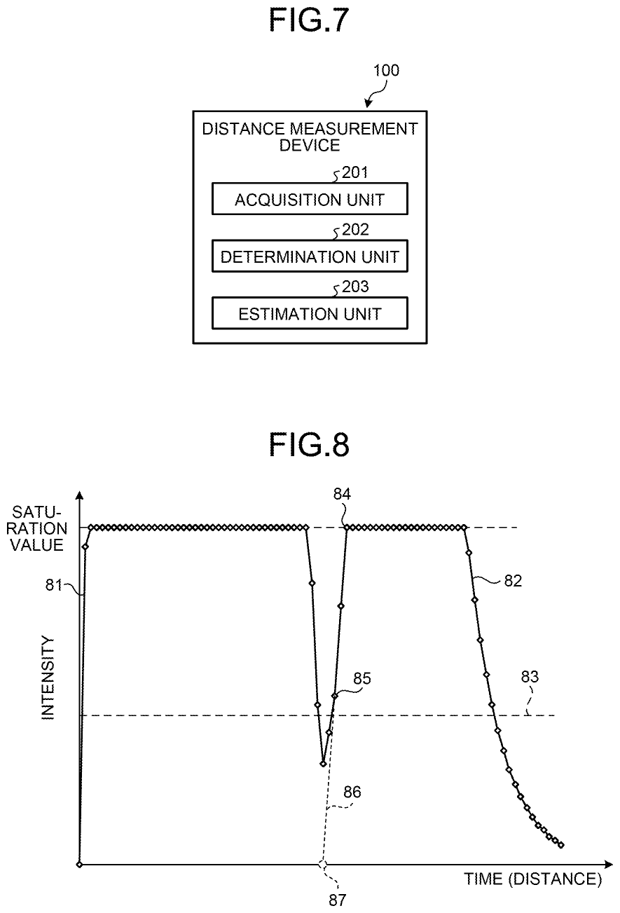

FIG. 7 is a diagram illustrating an example of a functional configuration of a distance measurement device 100 (a memory, and a hardware processor coupled to the memory) according to the present embodiment. The distance measurement device 100 may be implemented by the controller 14 of the sonar 10 or may be implemented by the ECU 20. Furthermore, the distance measurement device 100 may be implemented by a combination of the sonar 10 and the ECU 20. Furthermore, the distance measurement device 100 may be a device independent of the sonar 10 and the ECU 20.

As illustrated in FIG. 7, the distance measurement device 100 includes an acquisition unit 201, a determination unit 202, and an estimation unit 203. Note that, in the example of FIG. 7, only the functions related to the present embodiment are illustrated, but the functions of the distance measurement device 100 are not limited thereto.

The acquisition unit 201 acquires a reflected wave indicating a sound wave reflected by and returning from the obstacle OB present around the vehicle 1, in the transmission wave transmitted by the sonar 10 mounted on the vehicle 1. Specifically, the sonar 10 mounted on the vehicle 1 transmits the transmission wave. The transmitted transmission wave hits the obstacle OB present around the vehicle 1. Once the transmission wave hits the obstacle OB, the sound wave is reflected by the obstacle OB and returns. The sonar 10 receives the reflected wave indicating the sound wave reflected by and returning from the obstacle OB. The acquisition unit 201 acquires the reflected wave received by the sonar 10. Note that the acquisition unit 201 is also referred to as a transmission and reception unit.

The determination unit 202 determines whether or not an intersection point indicating a point where reverberation information (hereinafter, also referred to as a reverberation curve) indicating a temporal change in reverberation of the transmission wave transmitted by the sonar 10 and reflected wave information indicating a temporal change in reflected wave reflected by the obstacle OB intersect each other exceeds a first threshold indicating a detection threshold of the reception intensity detectable by the sonar, the reverberation information and the reflected wave information being acquired by the acquisition unit 201.

Specifically, the determination unit 202 acquires the reverberation information indicating the temporal change in reverberation of the transmission wave transmitted by the sonar 10 and the reflected wave information indicating the temporal change in reflected wave reflected by the obstacle OB, the reverberation information and the reflected wave information being acquired by the acquisition unit 201. The determination unit 202 synchronizes times that are temporal changes of the reverberation information and the reflection information, and superimposes the reverberation information and the reflected wave information. The determination unit 202 acquires the intersection point indicating a point where the reverberation information and the reflected wave information intersect each other from a result of superimposing the reverberation information and the reflected wave information. The determination unit 202 determines whether or not the acquired intersection point exceeds the first threshold indicating the detection threshold of the reception intensity detectable by the sonar.

The determination unit 202 determines whether or not a maximum value of an amplitude of the reflected wave acquired by the acquisition unit 201 exceeds a second threshold indicating a threshold of a reflection intensity of reflection by the reflected wave. Specifically, the determination unit 202 acquires the maximum value of the amplitude of the reflected wave from the reflected wave information indicating the temporal change in reflected wave reflected by the obstacle OB and acquired by the acquisition unit 201. The determination unit 202 determines whether or not the maximum value of the amplitude of the reflected wave exceeds the second threshold indicating the threshold of the reflection intensity of reflection by the reflected wave. The second threshold indicating the threshold of the reflection intensity of reflection by the reflected wave is set to, for example, a maximum value of an amplitude of the reflection intensity.

Further, the determination unit 202 determines whether or not the reflected wave acquired by the acquisition unit 201 is present during a reverberation period indicated by the reverberation information. Specifically, the determination unit 202 acquires the reverberation information indicating the temporal change in reverberation of the transmission wave transmitted by the sonar 10 and the reflected wave information indicating the temporal change in reflected wave reflected by the obstacle OB, the reverberation information and the reflected wave information being acquired by the acquisition unit 201. The determination unit 202 synchronizes times that are temporal changes of the reverberation information and the reflection information, and superimposes the reverberation information and the reflected wave information. The determination unit 202 determines whether or not the reflected wave is present during the reverberation period indicated by the reverberation information from the result of superimposing the reverberation information and the reflected wave information.

In a case where the determination unit 202 determines that the intersection point indicating the point where the reverberation information indicating the temporal change in reverberation of the transmission wave transmitted by the sonar and the reflected wave information indicating the temporal change in reflected wave reflected by the obstacle OB intersect each other is below the first threshold indicating the detection threshold of the reception intensity detectable by the sonar, the estimation unit 203 estimates a rising position of the reflected wave based on a straight line defining the maximum value of the amplitude of the reflected wave acquired by the acquisition unit 201 and a value of the amplitude of the reflected wave that has exceeded the first threshold for the first time in the reflected wave information.

Here, a content in which the estimation unit 203 estimates the rising position of the reflected wave based on the straight line defining the maximum value of the amplitude of the reflected wave and the value of the amplitude of the reflected wave that has exceeded the first threshold for the first time in the reflected wave information will be described with reference to FIG. 8. FIG. 8 is a graph illustrating an example of an amplitude of a vibration signal when the distance measurement device 100 according to the first embodiment receives the reflected wave overlapping the reverberation.

A solid line in FIG. 8 is a graph illustrating an amplitude of a vibration signal when the sonar 10 receives the reflected wave. A solid line 81 is an example of the reverberation information, and indicates, for example, an amplitude of a drive signal and a vibration signal corresponding to the reverberation. A solid line 82 is an example of the reflected wave information, and indicates, for example, an amplitude of a vibration signal corresponding to the reflected wave. A saturation value of the sensor in FIG. 8 is the highest amplitude value that can be detected by the controller 14. Even when a voltage higher than the saturation value of the sensor is applied from the reception circuit 13 to the controller 14, the controller 14 detects the saturation value of the sensor as an amount corresponding to the voltage.

Here, as illustrated in FIG. 8, a first threshold 83 is the detection threshold of the reception intensity detectable by the sonar. A maximum value 84 of the amplitude of the reflected wave is a value received by the controller 14 and indicates the same value as the saturation value of the sensor. An intersection point 85 indicates a value of the amplitude of the reflected wave that has exceeded the first threshold for the first time in the reflected wave information. A straight line 86 is a straight line connecting the maximum value 84 and the intersection point 85. The estimation unit 203 estimates, based on the straight line 86 connecting the maximum value 84 of the amplitude of the reflected wave and the value of the amplitude of the reflected wave that has exceeded the first threshold for the first time in the reflected wave information, that an intersection point between the straight line 86 and an intensity value of 0 is a rising position 87 of the reflected wave.

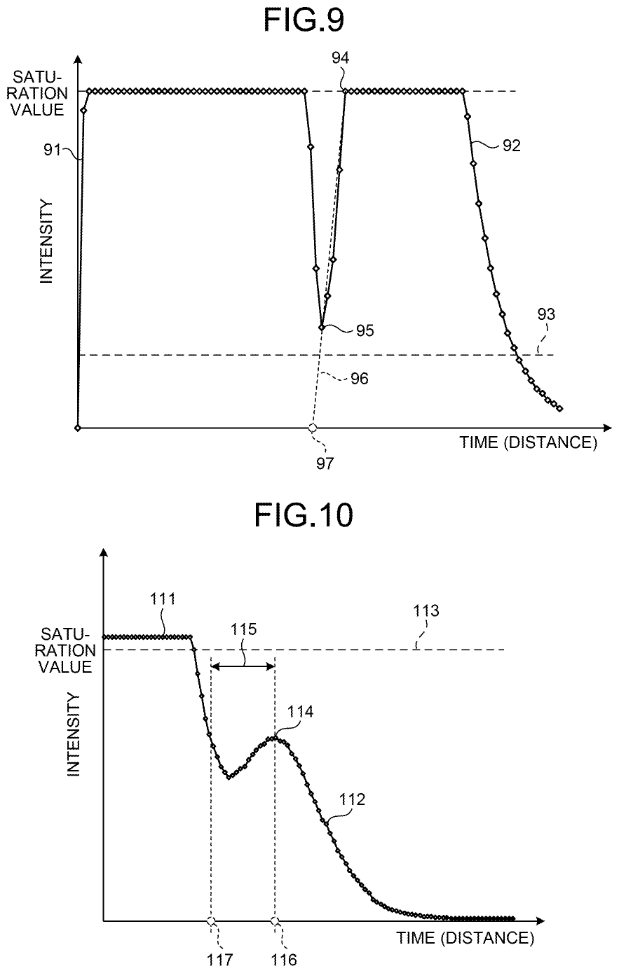

The description returns to FIG. 7. A content in which in a case where the determination unit 202 determines that the intersection point is equal to or greater than the first threshold, the estimation unit 203 estimates the rising position based on a straight line defining the maximum value of the amplitude of the reflected wave, and the intersection point indicating the point where the reverberation information and the reflected wave information intersect each other will be described. FIG. 9 is a graph illustrating an example of the amplitude of the vibration signal when the distance measurement device 100 according to the first embodiment receives the reflected wave overlapping the reverberation.

A solid line in FIG. 9 is a graph illustrating an amplitude of a vibration signal when the sonar 10 receives the reflected wave. A solid line 91 is an example of the reverberation information, and indicates, for example, an amplitude of a drive signal and a vibration signal corresponding to the reverberation. A solid line 92 is an example of the reflected wave information, and indicates, for example, an amplitude of a vibration signal corresponding to the reflected wave. A description of parts common to those in FIG. 8 described above will be omitted as appropriate. In FIG. 8 described above, the intersection point 85 indicates the value of the amplitude of the reflected wave that has exceeded the first threshold for the first time in the reflected wave information. On the other hand, an intersection point 95 of FIG. 9 is different from FIG. 8 described above in that the intersection point 95 indicates an intersection point between the reverberation information indicating the temporal change in reverberation of the transmission wave transmitted by the sonar and the reflected wave information indicating the temporal change in reflected wave reflected by the obstacle OB.

As illustrated in FIG. 9, a first threshold 93 is the detection threshold of the reception intensity detectable by the sonar. A maximum value 94 of the amplitude of the reflected wave is a value received by the controller 14 and indicates the same value as the saturation value of the sensor. The intersection point 95 indicates the intersection point between the reverberation information and the reflected wave information. A straight line 96 is a straight line connecting the maximum value 94 and the intersection point 95. The estimation unit 203 estimates that an intersection point between the straight line 96 and an intensity value of 0 is a rising position 97 of the reflected wave based on the straight line 96 connecting the maximum value 94 of the amplitude of the reflected wave and the intersection point indicating the point where the reverberation information indicating the temporal change in reverberation of the transmission wave transmitted by the sonar and the reflected wave information indicating the temporal change in reflected wave reflected by the obstacle OB intersect each other.

The description returns to FIG. 7. Moreover, in a case where the determination unit 202 determines that the maximum value of the amplitude of the reflected wave is less than the first threshold, the estimation unit 203 estimates the rising position based on the maximum value and a transmission pulse length indicating a duration of a pulse of the transmission wave transmitted by the sonar. In a case where the determination unit 202 determines that the reflected wave acquired by the acquisition unit 201 is not present during the reverberation period indicated by the reverberation information, the estimation unit 203 estimates the rising position based on the maximum value of the amplitude of the reflected wave and the transmission pulse length indicating the duration of the pulse of the transmission wave transmitted by the sonar.

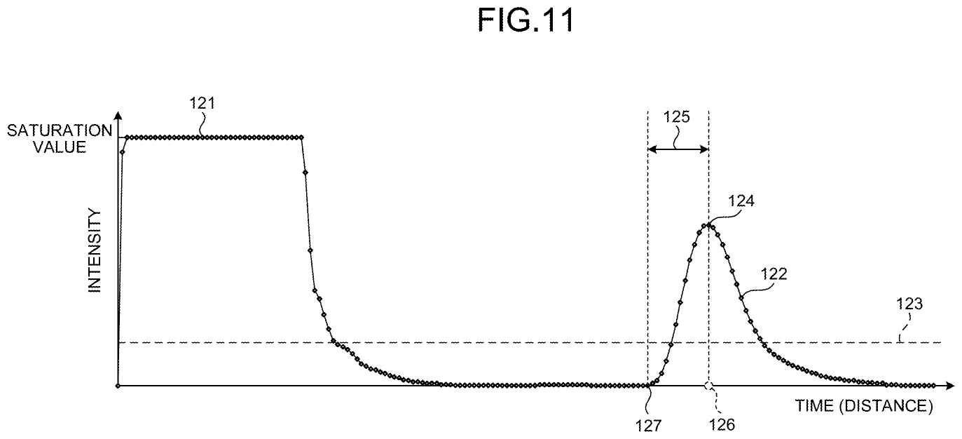

Here, a content in which the estimation unit 203 estimates the rising position based on the maximum value of the amplitude of the reflected wave and the transmission pulse length indicating the duration of the pulse of the transmission wave transmitted by the sonar will be described with reference to FIGS. 10 and 11. FIG. 10 is a graph illustrating an example of the amplitude of the vibration signal when the distance measurement device according to the first embodiment receives the reflected wave overlapping the reverberation. FIG. 11 is a graph illustrating an example of the amplitude of the vibration signal when the distance measurement device according to the first embodiment receives the reflected wave.

A solid line in FIG. 10 is a graph illustrating an amplitude of a vibration signal when the sonar 10 receives the reflected wave. A solid line 111 is an example of the reverberation information, and indicates, for example, an amplitude of a drive signal and a vibration signal corresponding to the reverberation. A solid line 112 is an example of the reflected wave information, and indicates, for example, an amplitude of a vibration signal corresponding to the reflected wave. A description of parts common to those in FIGS. 8 and 9 described above will be omitted as appropriate. In FIGS. 8 and 9 described above, the maximum value of the reflected wave is equal to or greater than the first threshold. On the other hand, FIG. 10 is different from FIGS. 8 and 9 described above in that the maximum value of the reflected wave is less than the second threshold indicating the threshold of the reflection intensity of reflection by the reflected wave.

As illustrated in FIG. 10, a maximum value 114 is the maximum value of the reflected wave received by the sonar. A transmission pulse length 115 is a transmission pulse length indicating the connection duration of the pulse of the transmission wave transmitted by the sonar. Here, the transmission pulse length will be described. The transmission pulse length is an integrated time from a time when the sonar starts transmission to a time 116 indicating the maximum value 114 of the amplitude of the transmission wave. As a result, since the time when the sonar starts transmission is known, the estimation unit 203 can estimate a rising position 117 based on a difference between the time 116 of the maximum value 114 of the amplitude of the reflected wave and the transmission pulse length 115 indicating the duration of the pulse of the transmission wave transmitted by the sonar.

A solid line in FIG. 11 is a graph illustrating an amplitude of a vibration signal when the sonar 10 receives the reflected wave. A solid line 111 in FIG. 11 is a graph illustrating an amplitude of a vibration signal when the sonar 10 receives the reflected wave. The solid line 111 is an example of the reverberation information, and indicates, for example, an amplitude of a drive signal and a vibration signal corresponding to the reverberation. The solid line 112 is an example of the reflected wave information, and indicates, for example, an amplitude of a vibration signal corresponding to the reflected wave. A description of parts common to those in FIG. 10 described above will be omitted as appropriate. In FIG. 10 described above, the maximum value of the amplitude of the reflected wave is equal to or greater than the second threshold, whereas FIG. 11 is different from FIG. 10 in that the reflected wave is not present during the reverberation period indicated by the reverberation information.

As illustrated in FIG. 11, a maximum value 124 is the maximum value of the amplitude of the reflected wave received by the sonar. A transmission pulse length 125 is a transmission pulse length indicating the connection duration of the pulse of the transmission wave transmitted by the sonar. The estimation unit 203 estimates a rising position 127 based on a difference between a time 126 of the maximum value 124 of the amplitude of the reflected wave and the transmission pulse length 125 indicating the duration of the pulse of the transmission wave transmitted by the sonar.

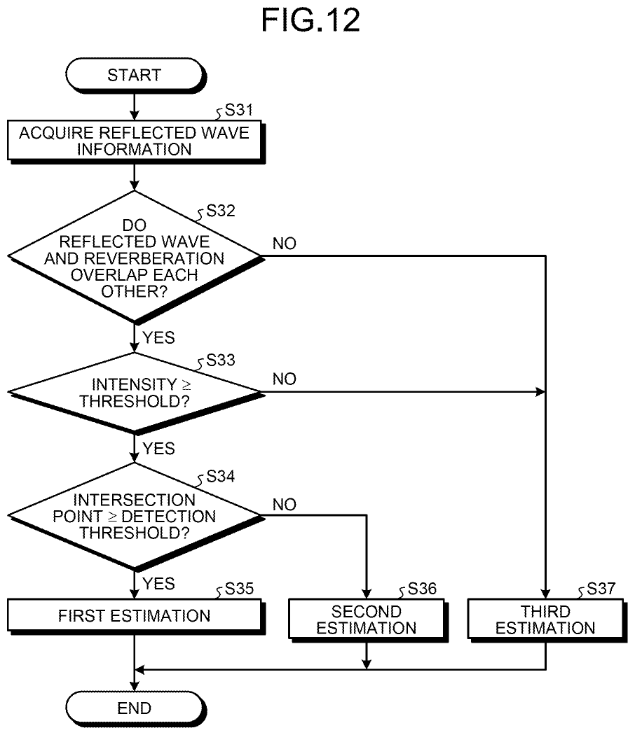

Next, an operation example of the distance measurement device 100 having the above-described configuration will be described with reference to FIG. 12. FIG. 12 is a flowchart illustrating an example of processing performed by the distance measurement device 100 according to the embodiment.

First, the acquisition unit 201 acquires the reflected wave indicating the sound wave reflected by and returning from the obstacle OB present around the vehicle 1, among the transmission waves transmitted by the sonar 10 mounted on the vehicle 1 (Step S31).

The determination unit 202 determines whether or not the reflected wave acquired by the acquisition unit 201 is present during the reverberation period indicated by the reverberation information (Step S32). Here, in a case where the reflected wave acquired by the acquisition unit 201 is present during the reverberation period indicated by the reverberation information (Step S32: Yes), the determination unit 202 proceeds to Step S33. On the other hand, in a case where the reflected wave acquired by the acquisition unit 201 in Step S32 is not present during the reverberation period indicated by the reverberation information (Step S32: No), the determination unit 202 proceeds to Step 37.

The determination unit 202 determines whether or not the maximum value of the amplitude of the reflected wave acquired by the acquisition unit 201 exceeds the first threshold (Step S33). Here, in a case where the maximum value of the amplitude of the reflected wave acquired by the acquisition unit 201 exceeds the first threshold (Step S33: Yes), the determination unit 202 proceeds to Step S34. On the other hand, in a case where the maximum value of the amplitude of the reflected wave acquired by the acquisition unit 201 does not exceed the first threshold in Step S33 (Step S33: No), the determination unit 202 proceeds to Step 37.

Further, the determination unit 202 determines whether or not the intersection point indicating the point where the reverberation information indicating the temporal change in reverberation of the transmission wave transmitted by the sonar 10 and the reflected wave information indicating the temporal change in reflected wave reflected by the obstacle OB intersect each other exceeds the first threshold indicating the detection threshold of the reception intensity detectable by the sonar, the reverberation information and the reflected wave information being acquired by the acquisition unit 201 (Step S34).

Here, in a case where the intersection point between the reverberation information and the reflected wave information acquired by the acquisition unit 201 exceeds the first threshold (Step S34: Yes), the determination unit 202 proceeds to Step S35. On the other hand, in a case where the intersection point between the reverberation information and the reflected wave information acquired by the acquisition unit 201 does not exceed the first threshold in Step S34 (Step S34: No), the determination unit 202 proceeds to Step 36.

In a case where the intersection point indicating the point where the reverberation information indicating the temporal change in reverberation of the transmission wave transmitted by the sonar and the reflected wave information indicating the temporal change in reflected wave reflected by the obstacle OB intersect each other is below the first threshold indicating the detection threshold of the reception intensity detectable by the sonar, the estimation unit 203 performs processing of performing first estimation in which a rising position of the reflected wave is estimated based on the straight line defining the maximum value of the amplitude of the reflected wave acquired by the acquisition unit and the value of the amplitude of the reflected wave that has exceeded the first threshold for the first time in the reflected wave information (Step S35).

Furthermore, in a case where the intersection point between the reverberation information and the reflection information is equal to or greater than the first threshold, the estimation unit 203 performs processing of performing second estimation in which the rising position is estimated based on the straight line defining the maximum value of the amplitude of the reflected wave and the intersection point (Step S36).

Furthermore, in a case where the maximum value of the amplitude of the reflected wave is less than the first threshold, or in a case where the reflected wave acquired by the acquisition unit 201 is not present during the reverberation period indicated by the reverberation information, the estimation unit 203 performs processing of performing third estimation in which the rising position is estimated based on the maximum value of the amplitude of the reflected wave and the transmission pulse length indicating the duration of the pulse of the transmission wave transmitted by the sonar (Step S37).

As described above, in the present embodiment, the reflected wave is acquired from the obstacle present around the vehicle among the transmission waves transmitted by the sonar mounted on the vehicle. In a case where the intersection point indicating the point where the reverberation information indicating the temporal change in reverberation of the transmission wave and the reflected wave information indicating the temporal change in reflected wave intersect each other is below the first threshold indicating the detection threshold of the reception intensity detectable by the sonar, the rising position of the reflected wave is estimated based on the straight line defining the maximum value of the amplitude of the reflected wave and the value of the amplitude of the reflected wave that has exceeded the first threshold for the first time in the reflected wave information.

According to the configuration of the present embodiment described above, even in a case where the reflected wave from the obstacle and the reverberation of the transmission wave of the sonar overlap each other, the rising position of the reflected wave can be estimated based on the maximum value of the amplitude of the reflected wave and the value of the amplitude of the reflected wave that has exceeded the threshold indicating the detection threshold of the reception intensity detectable by the sonar for the first time. As a result, even in a case of a short distance, since the rising position of the reflected wave from the obstacle can be estimated, more accurate distance information from the obstacle can be obtained.

### Second Embodiment

A second embodiment will be described with reference to the drawings.

Next, the second embodiment will be described. A description of a portion overlapping with the first embodiment described above will be omitted as appropriate. In the first embodiment described above, the acquisition unit that acquires a reflected wave indicating a sound wave reflected by and returning from an obstacle present around a vehicle, in a transmission wave transmitted by an ultrasonic sensor mounted on the vehicle transmits; and the estimation unit that estimates, in a case where an intersection point indicating a point where reverberation information indicating a temporal change in reverberation of the transmission wave transmitted by the ultrasonic sensor and reflected wave information indicating a temporal change in reflected wave reflected by the obstacle is below a first threshold indicating a detection threshold of a reception intensity detectable by the ultrasonic sensor, a rising position of the reflected wave based on a straight line defining a maximum value of an amplitude of the reflected wave acquired by the acquisition unit and a value of the amplitude of the reflected wave that has exceeded the first threshold for the first time in the reflected wave information are included.

On the other hand, the present embodiment is different from the first embodiment described above in that: a transmission and reception unit that transmits a transmission wave that is an ultrasonic wave and receives a reflected wave generated by the transmission wave; a detection unit that detects a reception signal received by the transmission and reception unit and obtains a reception waveform indicating a temporal change in intensity of the reception signal; a feature amount detection unit that detects a feature amount of the reflected wave based on the reception waveform; a measurement distance calculation unit that calculates a distance from the distance measurement device to an object as a measurement distance based on the feature amount; a predicted distance calculation unit that calculates a predicted distance obtained by predicting, based on the measurement distance, a measurement distance in a next measurement; a detection condition control unit that controls a detection condition related to detection of the feature amount; and an output control unit that outputs the measurement distance or the predicted distance as an output value are included, in which in a case where the reflected wave arrives during a reverberation period in which reverberation of the transmission wave remains in the transmission and reception unit, the detection condition control unit adjusts the detection condition based on the predicted distance, and in a case where a predicted distance output condition for outputting the predicted distance as the output value is satisfied, the output control unit outputs the predicted distance as the output value instead of the measurement distance.

Functional Configuration Diagram of Distance Measurement Device

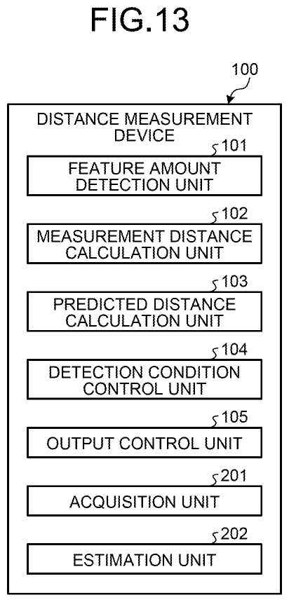

A distance measurement device 100 according to the second embodiment will be described with reference to FIG. 13. FIG. 13 is a block diagram of the distance measurement device 100. The distance measurement device 100 includes a feature amount detection unit 101, a measurement distance calculation unit 102, a predicted distance calculation unit 103, a detection condition control unit 104, an output control unit 105, an acquisition unit 201, a determination unit 202, and an estimation unit 203.

The feature amount detection unit 101 detects a feature amount of the reflected wave RW1 generated by the transmission wave reflected by the object based on the reception waveform. The feature amount detection unit 101 detects the feature amount based on the detection condition adjusted by the detection condition control unit 104. As will be described in detail later, the feature amount detection unit 101 detects, as the feature amount, position information of a peak of the reflected wave RW1 on the reception waveform, position information of an intersection point with a threshold, position information of an intersection point with the saturation value, or the like.

The position information is a combination of a time difference between a time of a specified time point and a time when an ultrasonic wave is transmitted and an intensity value at the specified time point. Since this time can be converted into a distance with a sonar as a starting point, it may be said that the position information is a combination of the distance and the intensity. Hereinafter, in order to avoid complicated description, detecting the feature amount of the reflected wave RW1 may be referred to as detecting the reflected wave, and the position information on the reception waveform may be abbreviated as a position. In addition, a horizontal axis of the reception waveform represents time, but on the premise that time is converted into distance, the horizontal axis of the reception waveform may represent a distance.

The measurement distance calculation unit 102 calculates, as the measurement distance, a distance from the sonar 10 to the object such as an obstacle based on the reflected wave RW1. For example, in a case where the position of the intersection point between the reflected wave RW1 by the sonar 10 and the threshold is detected, the measurement distance calculation unit 102 calculates the distance from the sonar 10 to the object as the measurement distance based on a time difference between a time point at which the reflected wave RW1 intersects the threshold and a time point at which the ultrasonic wave is transmitted. Note that a calculation method for calculating the distance from the position of the intersection point with the threshold is merely an example, and other calculation methods will be introduced later.

The predicted distance calculation unit 103 calculates the predicted distance obtained by predicting the measurement distance in the next measurement. The predicted distance calculation unit 103 calculates the predicted distance by a known method using information on the speed, acceleration, and traveling direction of the vehicle 1 and the latest measurement distance. The detection condition control unit 104 controls the detection condition related to the detection of the feature amount. For example, the detection condition control unit 104 specifies the reverberation curve indicating a reverberation attenuation process, and adjusts the detection condition of the feature amount based on the reverberation curve. The detection condition of the feature amount is, for example, the threshold. The output control unit 105 controls a content to be output as the distance. For example, the output control unit 105 outputs one of the measurement distance or the predicted distance.

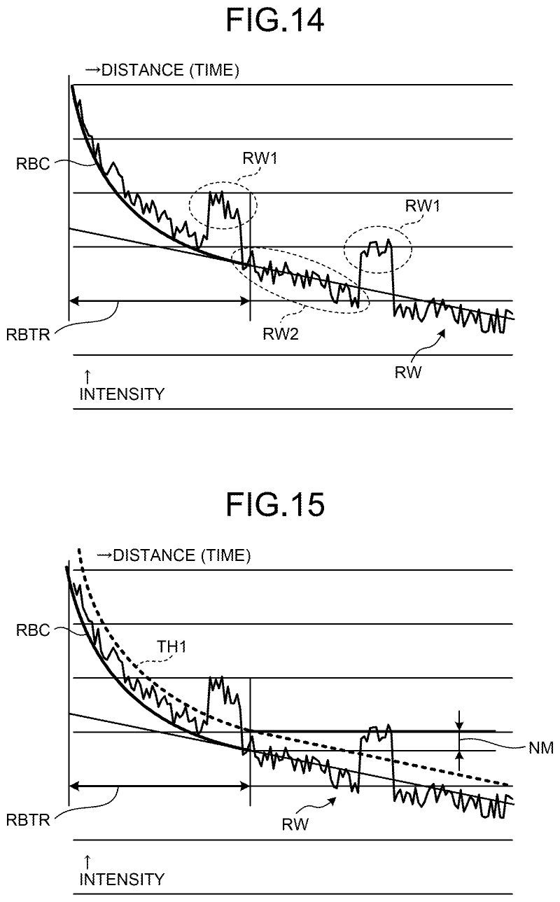

Here, a method in which the detection condition control unit 104 specifies the reverberation curve will be described with reference to FIG. 14. FIG. 14 is a diagram illustrating a reception waveform RW including a reverberation period RBTR. The reception waveform RW includes a waveform of a portion of the reverberation period RBTR indicating the reverberation attenuation process, the reflected wave RW1 from the obstacle OB, and a reflected wave RW2 from the road surface RS. The detection condition control unit 104 may specify the reverberation curve RBC by processing the waveform of the portion of the reverberation period RBTR of the reception waveform RW.

A bottom side of the reception waveform RW is reflection from the road surface RS (road surface reflection), and a portion rising from the road surface reflection is the portion of the reverberation period RBTR. The reverberation period RBTR can be said to be a period until the reverberation becomes weaker than the road surface reflection. In the reverberation period RBTR, a noise or the reflected wave RW1 overlaps the reverberation curve RBC. Since the noise randomly occurs, the detection condition control unit 104 acquires the reception waveform RW a plurality of times and suppresses a noise component by performing averaging processing of averaging the reception waveform RW of the portion of the reverberation period RBTR.

Since the reflected wave from the obstacle OB does not always exist, the detection condition control unit 104 may exclude the reception waveform RW when the reflected wave RW1 from the obstacle OB is detected from a target of the averaging processing, or may perform averaging processing on the reception waveform RW from which the reflected wave RW2 from the obstacle OB is removed.

Furthermore, since the reverberation attenuates according to the exponential curve, the detection condition control unit 104 may specify the reverberation curve by using a regression analysis method. For example, the detection condition control unit 104 may perform logarithmic transformation on the reception intensity of the reverberation period RBTR, and specify a coefficient of an exponential function in a regression equation to specify the reverberation curve RBC.

With such processing, the detection condition control unit 104 can specify the reverberation curve based on the reception waveform RW. The controller 14 stores the reverberation curve specified based on the reception waveform RW, and can use the reverberation curve for subsequent detection.

Furthermore, although the reverberation attenuates according to the exponential function, since a speed of attenuation varies depending on each sonar 10, the speed of attenuation may be specified as a characteristic value, and this characteristic value may be stored instead of the reverberation curve. For example, the detection condition control unit 104 may specify the coefficient of the exponential function or a value related to the coefficient as a characteristic value indicating a characteristic of reverberation attenuation of the sonar 10, store the specified characteristic value, and specify the reverberation curve based on the characteristic value at the time of shipment of the distance measurement device or the vehicle including the distance measurement device.

For example, since there is a predetermined relationship between an impedance of the sonar 10 and the reverberation curve, the detection condition control unit 104 may obtain the impedance of the sonar 10 at the time of starting the distance measurement device 100 or the like and store the impedance as the characteristic value.

In this manner, the detection condition control unit 104 can more appropriately specify the reverberation curve by correcting the reverberation curve based on the characteristic value.

Next, an example of adjusting the detection condition based on the reverberation curve will be described with reference to FIG. 15. FIG. 15 is a diagram illustrating a threshold for detecting the reflected wave portion RW1. As illustrated in FIG. 15, the detection condition control unit 104 sets a curve shifted upward by adding a noise margin NM to the reverberation curve RBC as a threshold TH1 for detecting the reflected wave RW1, in the reverberation period RBTR.

The noise margin NM is, for example, about 3 dB. Even in a road surface reflection period that is not the reverberation period RBTR, the detection condition control unit 104 may use, as the threshold, a value obtained by adding the same noise margin as in the reverberation period RBTR to a level (an intensity averaged on a time axis) of the reflected wave from the road surface. In this case, in a case where the reverberation period RBTR is a period until the reverberation curve attenuates to the level of the reflected wave from the road surface, discontinuity of the threshold TH1 does not occur at a boundary between the reverberation period and the road surface reflection period.

The detection condition control unit 104 may set the noise margin to a fixed value, or may calculate an amplitude of a noise from the reception waveform in a period other than the reverberation period RBTR and determine the noise margin so as not to fall below the amplitude of the noise.

In this manner, the detection condition control unit 104 sets the curve obtained by shifting the reverberation curve RBC upward as the threshold TH1, and the feature amount detection unit 101 detects the reflected wave RW1 based on the threshold TH1, whereby a possibility of detecting the reflected wave RW1 even during the reverberation period RBTR can be increased.

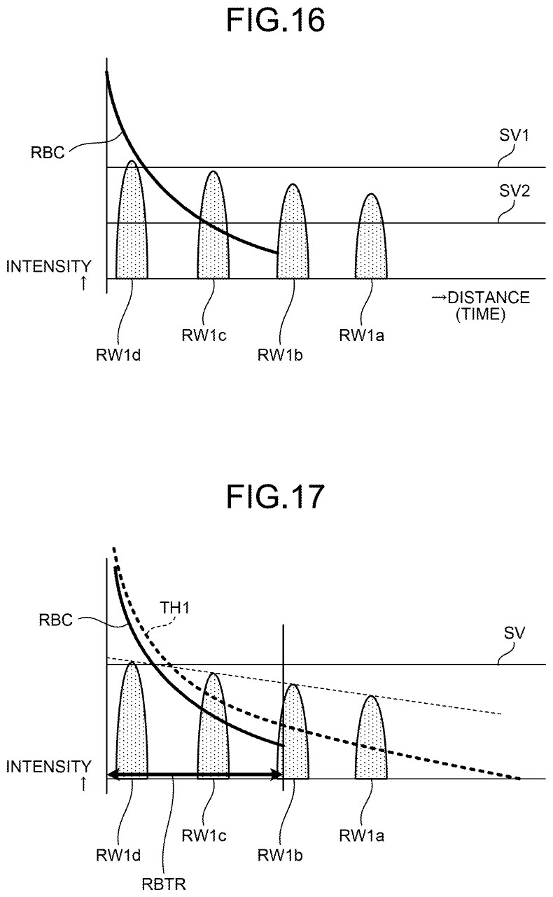

Meanwhile, there is an upper limit value in data of the reception waveform, and when the intensity of the reverberation or the reflected wave exceeds an intensity corresponding to the upper limit value, the data uniformly becomes the upper limit value regardless of the actual intensity. The intensity corresponding to the upper limit value is referred to as the saturation value. A relationship between the saturation value and reflected wave RW1 will be described with reference to FIG. 16. FIG. 16 is a diagram illustrating the relationship between the saturation value and the reflected wave. In FIG. 16, the reflected waves from the object whose distance from the sonar as the starting point gradually decreases due to the approach are arranged on one reception waveform.

As illustrated in FIG. 16, in a case where the saturation value is SV2, since the reverberation intensity indicated by the reverberation curve RBC exceeds the saturation value SV2 before a reflected wave RW1c is received, the data is uniformly the upper limit value. Also at a timing when the reflected wave RW1c is received, the data remains at the upper limit value, and thus the distance measurement device 100 cannot detect the reflected wave RW1c.

When the detection condition control unit 104 lowers a transmission intensity of the sonar 10 or lowers an amplification degree of the reception signal to adjust and lower the reception intensity, the saturation value can be relatively increased. Then, when the saturation value becomes SV1, the feature amount detection unit 101 can detect the reflected wave such as RW1c.

Note that even when the saturation value becomes SV1, the reflected wave such as RW1d cannot be detected. At this time, since the shortest distance that can be detected is determined by an intersection point between the reverberation curve and the saturation value, in a case where the shortest distance that needs to be detected is determined, the saturation value may be determined in advance according to the reverberation curve.

When the transmission intensity is lowered or the amplification degree of the reception signal is lowered in order to increase the saturation value, it becomes difficult to detect a weak reflected wave. Therefore, the detection condition control unit 104 may perform a control to increase the saturation value in advance only when it is necessary to detect a short distance, for example, at the time of parking, or may perform a control to increase the saturation value only when it is found that an approach state in which the reflected wave is received in the reverberation period occurs as a result of calculating the predicted distance. The distance measurement device 100 can control the saturation value by acquiring information indicating a parking state from the ECU 20.

Next, a condition under which the reflected wave RW1 can be detected will be described with reference to FIG. 17. FIG. 17 is a diagram illustrating a relationship among the saturation value SV, the threshold TH1, and the reverberation curve RBC. As illustrated in FIG. 17, since the detection condition control unit 104 sets a curve obtained by adding the noise margin to the reverberation curve RBC as the threshold TH1, the threshold TH1 may exceed the saturation value SV in the reverberation period RBTR. In a section where the threshold TH1 exceeds the saturation value SV, since received data does not exceed the threshold TH1, the distance measurement device 100 cannot detect the reflected wave RW1.

In addition, the reflected wave RW1d cannot be detected even in a section where the reflected wave RW1d does not reach the reverberation curve RBC, but a section where the reflected wave RW1d cannot be detected because the threshold TH1 exceeds the saturation value SV is wider. Since the threshold TH1 is determined by the reverberation curve, it can be said that a period in which the reflected wave cannot be detected is determined by the reverberation curve RBC. In a case where the threshold TH1 is a distance exceeding the saturation value SV as a result of calculating the predicted distance, the distance measurement device 100 may determine that the detection condition cannot be adjusted in such a manner that the reflected wave can be detected.

In addition, in a case where the distance measurement device 100 has attempted to detect the reflected wave RW1 and has failed to detect the reflected wave RW1, it may be determined that the reflected wave RW1 is not detected. As described above, in a case where the distance measurement device 100 cannot detect the reflected wave RW1 with the threshold TH1, the output control unit 105 of the distance measurement device 100 outputs the predicted distance instead of the measurement distance. As a result, the distance measurement device 100 can output the distance even in a situation where the reflected wave RW1 cannot be detected due to the relationship among the reverberation curve RBC, the threshold TH1, and the saturation value SV.

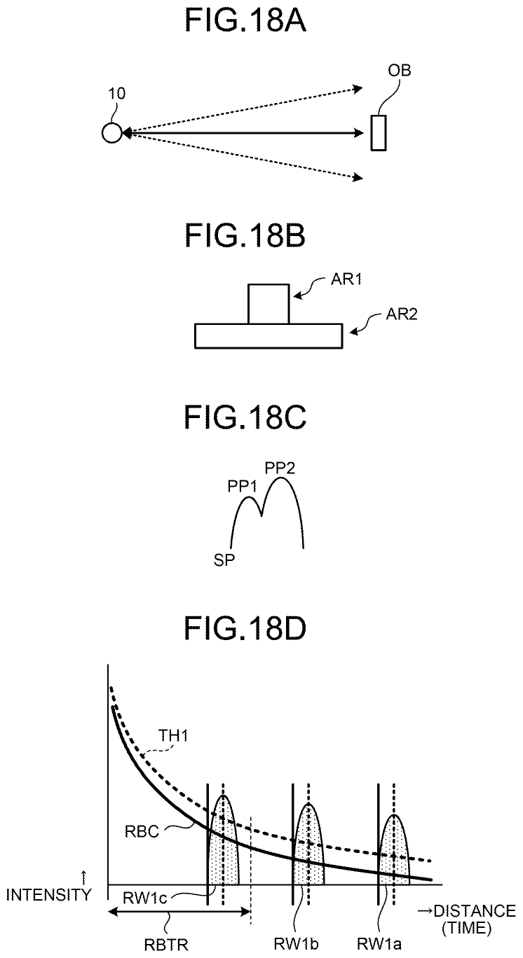

Next, a position for calculating the distance among the reflected waves RW1 will be described with reference to FIGS. 18A to 18D. As illustrated in FIG. 18A, in a case where an ultrasonic wave is output from the sonar 10 and is reflected by the obstacle OB accordingly, not only a sound wave reflected by a closest point which is a point closest to the sonar 10 but also a sound wave reflected from the vicinity of the closest point reaches the sonar 10.

As illustrated in FIG. 18B, a case where a protrusion such as an area AR1 exists at an area AR2 will be considered. A sound wave reflected from the area AR1 which is the closest point reaches the sonar 10 earliest, but a sound wave reflected from the surrounding area AR2 having a larger area than that of the area AR1 and reaching the sonar 10 after the sound wave reflected from the area AR1 tends to have a higher intensity.

Therefore, as illustrated in FIG. 18C, the reflected wave RW1 forms two peaks PP1 and PP2 of the signal intensity. In selection of which peak time point should be used to calculate the distance, since the sonar is equipped for the purpose of collision prevention and a distance necessary for collision prevention is a distance to the closest point, the earlier PP1 should be selected to calculate the distance.

However, with some detection thresholds, it is not always possible to detect the two peaks separately, and a peak position in a case where the two peaks are detected as one combined peak is the position of PP2 having a higher intensity. In a case where only one of the two peaks is detected, there is a high probability that PP2 having a higher intensity is detected. Therefore, it is desirable to calculate the distance based on a rising time point SP instead of PP1 or PP2 that is the peak time point of the signal intensity.

However, during the reverberation period, since a bottom portion of the reflected wave is hidden by the reverberation, a waveform of the reflected wave cannot be observed near the rising time point SP. Therefore, as illustrated in FIG. 18D, for example, the measurement distance calculation unit 102 specifies a peak position and a rising position at a time point at which the reflected wave RW1a is detected, and calculates a time difference between a peak time point and a rising time point. The rising position is hidden by the reverberation and is thus difficult to estimate at a time point of the reflected wave RW1c, but at a time point of the reflected wave RW1a, the influence of reverberation and the influence of the road surface reflection are small, so that estimation can be performed with a relatively small error.

Assuming that the time difference between the peak position and the rising position is the same even at the time point of the reflected wave RW1c, the measurement distance calculation unit 102 can estimate the rising position from the peak position at the time point of the reflected wave RW1c and the time difference. Even when a difference between intensity values of the reflected wave and the reverberation decreases, the peak position can be specified, and thus, the rising position can be specified even in a case of a short distance.

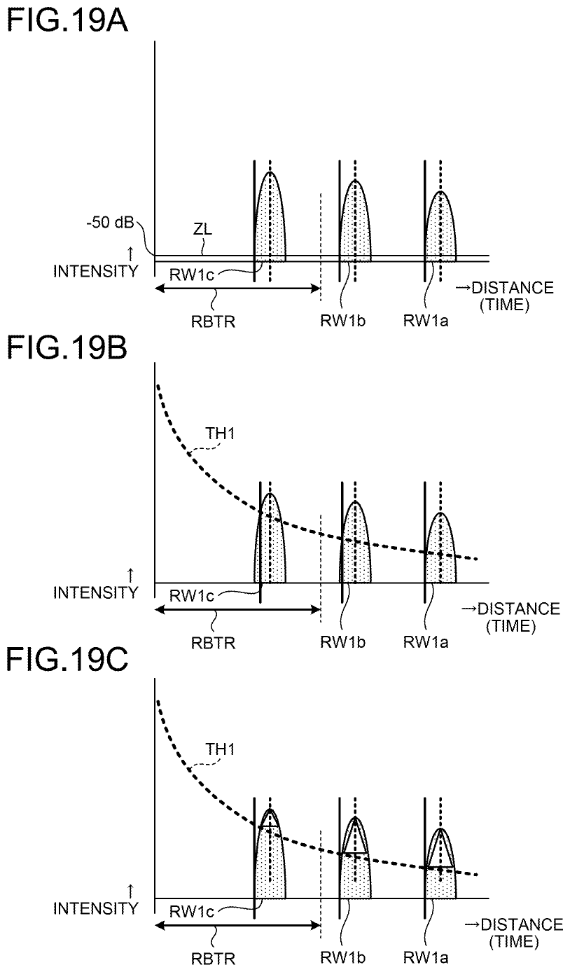

Next, a method of specifying the peak position and the rising position will be described with reference to FIGS. 19A to 19C. An actual rising time point is a time point at which the intensity of the reflected wave rises from zero, but as indicated by the reverberation curve RBC, the reverberation attenuates according to the exponential function, and thus, the reception waveform does not become zero. That is, a waveform in which the intensity of the reflected wave rises from zero cannot be observed. Therefore, a practical zero level ZL larger than zero is determined, and an intersection point between the reflected wave and a line of the zero level ZL is set as a practical rising point.

FIG. 19A illustrates an example in which the practical zero level ZL is set to, for example, −50 dB, and a time point at which the practical zero level intersects an intensity distribution of the reflected wave, that is, an intersection point between the zero level ZL and the reflected wave RW1 is set as a practical rising time point. However, the reflected wave is hidden and cannot be observed due to the influence of the reverberation or road surface reflection in the vicinity of the point where the reflected wave intersects with the zero level ZL, it is necessary to perform processing of estimating the waveform of the reflected wave in a range where the observation cannot be performed, and extend the waveform of the reflected wave to a line of the zero level ZL.

FIG. 19B illustrates an example in which a time point at which the threshold TH1 intersects the intensity distribution of the reflected wave RW1, that is, an intersection point between the threshold TH1 and the reflected wave RW1 is set as the practical rising time point. In this case, since the rising time point is determined by comparison between the waveform of the reflected wave within the observable range and the threshold, implementation is easier. In terms of accuracy, it can be said that the latter is inferior in accuracy since a difference between the practical rising time point and the actual rising time point is large, but since it can also be said that there is no large difference, the latter may be adopted depending on the required accuracy.

In addition, since the noise overlaps the reflected wave, a point where the reflected wave has a maximum value changes depending on a position to which the noise is applied. Therefore, in a case where the calculation is performed assuming that a position where the reflected wave has the maximum value is the peak position, the calculated distance may become unstable.

FIG. 19C illustrates a method of stably specifying the peak time point. For example, a time point of the intersection point between the threshold and the reflected wave RW1 and a time point at which the intensity is the same as the intersection point on a downward slope of the reflected wave RW1 are obtained, and a time point at a midpoint between these time points is set as the peak time point. As described above, when the entire waveform information of the observable reflected wave RW1 is used, the distance can be stably calculated even when the noise is added to the reflected wave.

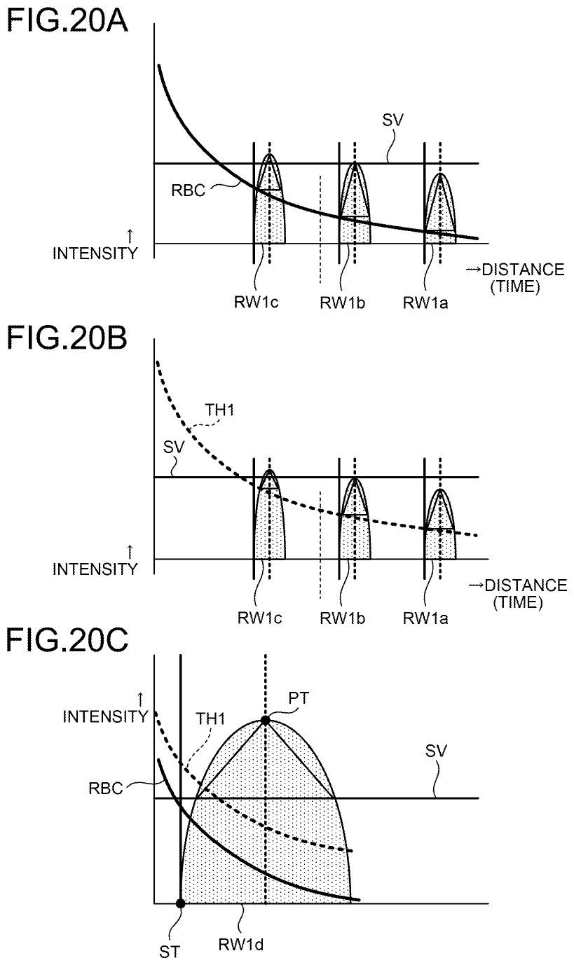

Next, processing in a case where the vicinity of the peak is saturated will be described with reference to FIGS. 20A to 20C. A method of specifying two points on a line corresponding to the same intensity on an upward slope and a downward slope of the peak and estimating that there is a peak at a midpoint between the two points illustrated in FIG. 19C may be paraphrased as an operation of geometrically approximating the waveform of the reflected wave RW1 with an isosceles triangle and applying two vertexes of the lower side to the upward slope and the downward slope. This method uses a point on the upward slope and a point on the downward slope sandwiching the peak, and does not use a waveform in the vicinity of the peak. Therefore, this method can also be applied to a case where the waveform in the vicinity of the peak cannot be observed due to saturation.

A point at which the lower left vertex of the isosceles triangle is applied to the reflected wave RW1 may be an intersection point between the reflected wave RW1 and the reverberation curve as illustrated in FIG. 20A, or may be an intersection point with the road surface reflection curve. The RBC in FIG. 20A is a curve in which the reverberation curve and the road surface reflection curve are continuous. The road surface reflection curve is obtained by estimating an intensity curve of the road surface reflection when there is no obstacle, and can be obtained by a method similar to the method of estimating the reverberation curve from the reception waveform described above.

As illustrated in FIG. 20B, the lower left vertex of the isosceles triangle may be an intersection point between the reflected wave RW1 and the threshold TH1. Like the reflected wave RW1c in FIGS. 20A and 20B, when the vicinity of the peak is saturated, the intensity of the peak cannot be specified. However, since it is sufficient that the distance can be specified in the distance measurement, there is no problem even if there is no intensity information.

FIG. 20C illustrates a method of applying the vertexes of the lower side of the isosceles triangle to oblique sides, and illustrates the vicinity of the vertexes in an enlarged manner. SV is the level of the reception intensity corresponding to the saturation value, and is referred to as the saturation value SV. In a section where the reflection intensity curve exceeds the saturation value SV, waveform data is saturated at a maximum value and thus has the same value. The maximum value is, for example, 255 when the waveform data is 8-bit data.

That is, when the reflection intensity curve exceeds the saturation value SV, the position of the peak of the reflected wave cannot be specified as the point at which the waveform data has the maximum value. However, in a case where a portion from a left end to a right end of the section where the waveform data of the reflected wave RW1d is saturated at the maximum value is the lower side of the isosceles triangle approximating the waveform of the peak portion, it can be specified that there is a peak at the midpoint.

Since this method is applicable only when the vertex of the reflected wave exceeds the saturation value SV, for example, when the peak exceeds the saturation value SV, a method of specifying that there is a peak in a distance of the midpoint of the lower side in a case where a portion from the left end to the right end of the section where the waveform data of the reflected wave RW1d is saturated is set as the lower side of the isosceles triangle, or otherwise an intensity value of the intersection point between the reflected wave RW1 and the reverberation curve or an intensity value of the intersection point with the road surface reflection curve is set as a reference intensity value replacing the saturation value SV, and a range in which the waveform data exceeds the reference intensity value is set as the lower side of the isosceles triangle may be applied.

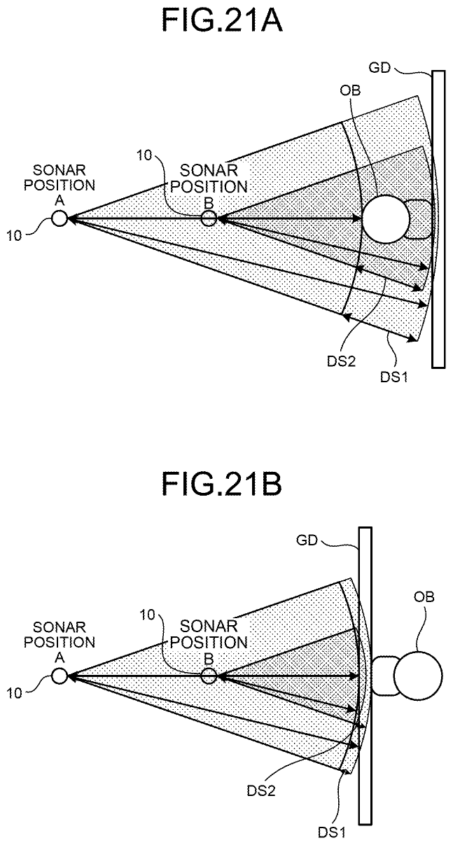

Next, adjustment of an offset between the peak position and the rising position will be described with reference to FIGS. 21A and 21B. Although it has been described in FIGS. 20A to 20C and the like that the offset between the peak position and the rising position is constant in order to simplify the description, the offset may be adjusted. The offset between the peak position and the rising position may be rephrased as a difference between a distance to the largest reflection surface and a distance (shortest distance) to the closest point. This distance difference depends on the shape of the object, and may change when approaching.

FIG. 21A is a layout diagram in a case where the obstacle OB such as a pillar is positioned in front of a guard rail GD. The shortest distance is a distance to the obstacle OB, and the distance to the largest reflection surface is generally a distance to the guard rail GD, and the distance difference does not change greatly even when the sonar 10 approaches. In FIG. 21B, the closest point is on the guard rail GD. The largest reflection surface is within a range hit by the sound wave, and is distant by a distance difference DS1 when the sonar 10 is at a position A.

When the sonar 10 approaches a sonar position B, the range hit by the sound wave is narrowed while maintaining a similar relationship. Therefore, a distance difference DS2 between the distance to the largest reflection surface and the distance to the closest point is smaller than the distance difference DS1 when the sonar 10 is at the sonar position A in proportion to the distance to the guard rail GD.

In FIG. 21B, since the distance to the GD is about half, the distance difference DS2 is also about half the distance difference DS1. When the object has a protruding portion as illustrated in FIG. 21A, a width of the reflected wave is large, or the peak portion is divided into two. On the other hand, when a reflection surface of the object is a flat surface, the reflected wave becomes sharp with a narrow peak width, and becomes sharper as distance from the object decreases.

Therefore, the shape of the obstacle OB may be estimated, and whether or not to adjust the offset may be determined according to the estimation result. For example, in a case where the offset between the peak position and the rising position is small at the position A, it may be determined that there is no protruding portion, and correction may be performed to reduce the offset in proportion to the distance.

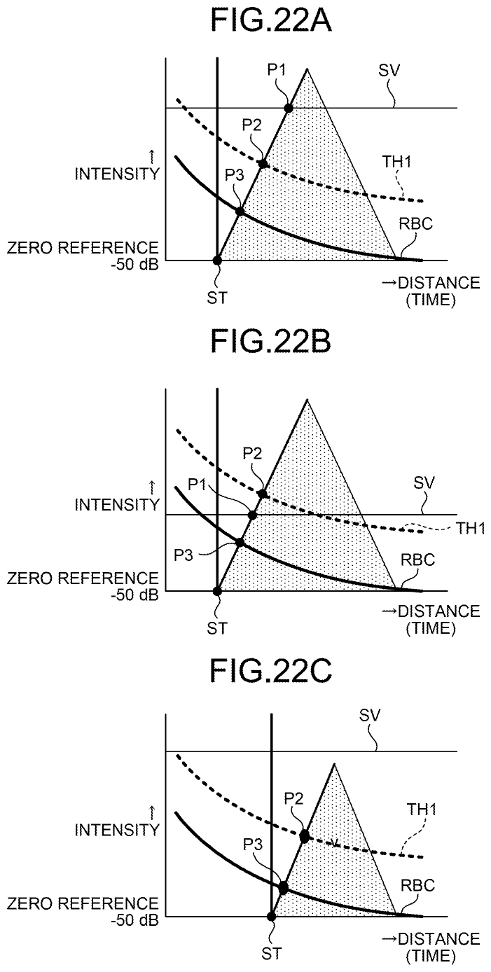

Next, a method of estimating the rising point from the waveform of the upward slope of the reflected wave RW1 will be described with reference to FIGS. 22A to 22C. Hereinabove, the method of specifying the peak position of the reflected wave RW1, specifying the offset between the rising position and the peak position before the object approaches, and estimating, as the rising position, a position obtained by subtracting the offset (or corrected offset) from the peak position at the time when the object approaches has been described. However, the rising position may be estimated from data of the upward slope of the peak.

This method may be rephrased as processing of approximating the entire reception waveform of the reflected wave with a triangle, specifying an oblique side as a straight line passing through two points on the reception waveform, and determining a lower left vertex. Assuming that a zero reference of the intensity of the rising position, that is, the intensity of the reflected wave is, for example, −50 dB, the rising position is specified as an intersection point between the straight line passing through two points on the reception waveform that is the oblique side and a −50 dB line.

In FIG. 22A, since the oblique side has a point P1 which is the intersection point between the reflected wave and the saturation value SV, a point P2 which is the intersection point between the reflected wave and the threshold, and a point P3 which is the intersection point between the reflected wave and the reverberation curve, the oblique side can be specified by selecting any two points from the points P1 to P3. For example, when the point P3 is greatly deviated from a line connecting the points P1 and P2, the oblique side may be specified by the points P1 and P2, and otherwise, the oblique side may be specified by the points P2 and P3.

In FIG. 22B, since the point P2 exceeds the saturation value SV and thus cannot be specified, the oblique side may be specified by the points P1 and P3. In FIG. 22C, since there is no point P1 which is the intersection point with the saturation value SV, the oblique side may be specified by the points P2 and P3.

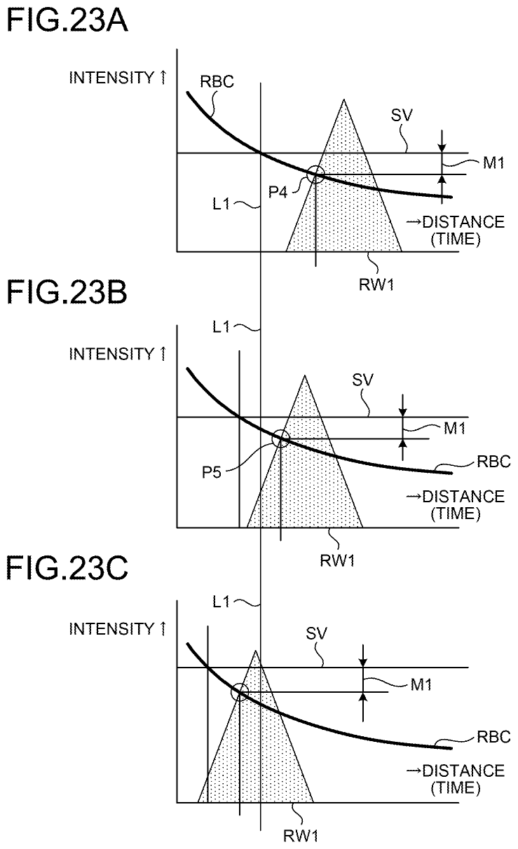

Next, a method of a dynamic control of the detection condition according to the reverberation curve will be described with reference to FIGS. 23A to 23C. In a case where the rising position is specified by two points on the oblique side of the reflected wave RW1, it is preferable that there is a margin of a predetermined value or more between the two points. For example, it is assumed that, before a state of FIG. 23A, there is a margin Ml of a predetermined threshold (for example, 10 dB) or more between a point P4 which is the intersection point between the reflected wave RW1 and the reverberation curve RBC, and the saturation value SV, and the point P4 is slightly below the margin Ml in the state of FIG. 23A.

When the arrival time of the reflected wave RW1 becomes earlier without changing the saturation value SV in the state of FIG. 23A, the point P4 which is the intersection point between the reflected wave RW1 and the reverberation curve RBC approaches the saturation value SV, and P4 exceeds the saturation value SV at a position beyond a line L1, so that the rising position cannot be specified using P4.

At this time, the detection condition control unit 104 predicts a point P5 which is an intersection point between the oblique side of the reflected wave RW1 and the reverberation curve RBC in the next detection, based on the approaching speed of the vehicle 1 so far by using the predicted distance calculated by the predicted distance calculation unit 103, and adjusts the transmission intensity of the sonar 10 or the amplification degree in such a manner that the point P5 and the saturation value SV exceed by the margin Ml. In a case where the saturation value SV is dynamically controlled, a time delay is less likely to occur and accuracy is more likely to be improved when the transmission intensity is digitally controlled than when the amplification degree in an analog circuit is adjusted.

In a case where the object approaches as predicted, a state of FIG. 23B is obtained. Here, when the prediction and the adjustment of the saturation value SV are repeated, a state of FIG. 23C is obtained. In a case where the saturation value SV remains as in FIG. 23A, when the reflected wave RW1 approaches beyond the line L1, the reverberation exceeds the saturation value SV, and thus the reflected wave RW1 cannot be detected. However, as described above, by controlling the saturation value SV in accordance with the predicted distance of the object and the saturation curve, even in a case where the point P4, which is the intersection point between the reflected wave RW1 and the reverberation curve RBC, exceeds the line L1, the reflected wave RW1 can be detected.

In this manner, the detection condition control unit 104 predicts the position of the reflected wave RW1 included in the reception waveform RW based on the predicted distance, specifies the intersection point between the predicted reflected wave RW1 and the reverberation curve RBC, and performs a control to increase the saturation value based on the intersection point and the margin with respect to the saturation value. As a result, the distance measurement device 100 can widen the range in which the distance can be measured despite the influence of the reverberation by increasing the saturation value SV.

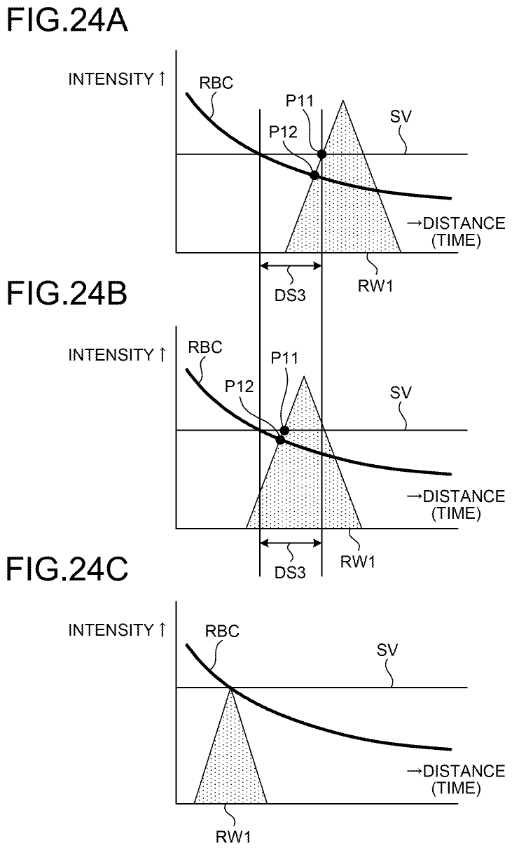

Next, a condition for determining that the reflected wave RW1 cannot be detected based on the predicted distance will be described with reference to FIGS. 24A to 24C. Hereinafter, a case where the intersection point between the reflected wave RW1 and the threshold is used will be described. However, in the method of specifying the rising position by two points on the oblique side of the reflected wave RW1, the intersection point between the reflected wave RW1 and the threshold does not have to be used. Therefore, it is sufficient that two arbitrarily selected points are applied.

In a case where the saturation value SV is not dynamically controlled, a distance between an intersection point P11 between the oblique side of the reflected wave RW1 and the saturation value SV and the intersection point between the reverberation curve RBC and the saturation value SV is defined as DS3 in FIG. 24A. In FIG. 24A, the rising position of the reflected wave RW1 can be estimated by extending a straight line connecting the intersection point P11 on the oblique side of the reflected wave RW1 and an intersection point P12 between the oblique side of the reflected wave RW1 and the reverberation curve RBC.

However, as the object approaches in a state of FIG. 24A, P11 and P12 also approach each other, and when the object approaches by the distance DS3, the intersection point P11 between the oblique side of the reflected wave RW1 and the saturation value SV and the intersection point P12 between the reverberation curve RBC and the oblique side of the reflected wave RW1 overlap and become one point, and thus, it is not possible to specify the rising position of the reflected wave by extending the line connecting the two points. That is, the distance measurement device 100 may determine that the reflected wave RW1 cannot be detected when the distance in FIG. 24A decreases by the distance DS3.

As illustrated in FIG. 24B, even when a distance by which the reflected wave RW1 has moved is less than the distance DS3, when two points approach each other, it is difficult to stably specify the rising position of the reflected wave RW1. Therefore, it may also be determined that the reflected wave RW1 cannot be detected when a difference between intensity values of the two points is less than a predetermined value (for example, 3 dB).

Further, as illustrated in FIG. 24C, when the reflected wave RW1 does not intersect the saturation value SV and the intersection point is thus not formed, the method of specifying the rising position by two points on the oblique side of the reflected wave RW1 cannot be applied. Therefore, it may be determined that the reflected wave RW1 cannot be detected.

Further, in a case where the intersection point between the reflected wave RW1 and the threshold is used, it may also be determined that the reflected wave RW1 cannot be detected when the reflected wave RW1 does not intersect the threshold and the intersection point is thus not formed, or when a difference in intensity value between the intersection point between the reflected wave RW1 and the threshold and the intersection point between the reflected wave RW1 and the reverberation curve RBC is less than a predetermined value. When it is determined that the reflected wave RW1 cannot be detected due to any of the conditions, the distance measurement device 100 outputs the predicted distance instead of the measurement distance.

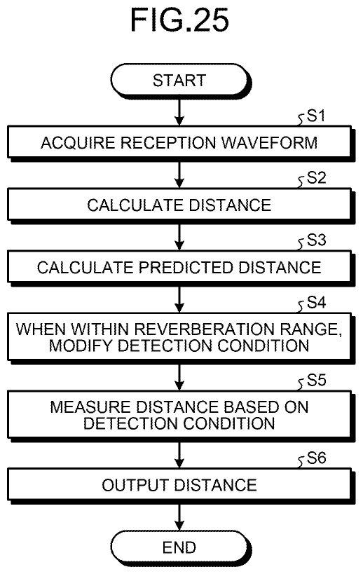

Next, a processing procedure in which the distance measurement device 100 measures the distance will be described with reference to FIG. 25. First, the feature amount detection unit 101 of the distance measurement device 100 acquires the reception waveform RW (Step S1), and detects the feature amount of the reflected wave RW1 based on the detection condition controlled by the detection condition control unit 104.

In a case where the feature amount of the reflected wave RW1 is detected, for example, in a case where the position of the intersection point between the reflected wave RW1 and the threshold TH is specified, the measurement distance calculation unit 102 calculates the measurement distance based on the feature amount (in this case, a distance from an origin on the reception waveform to the intersection point with the threshold in a horizontal axis direction) of the reflected wave RW1 (Step S2). The predicted distance calculation unit 103 calculates the predicted distance based on vehicle traveling information such as the speed of the vehicle 1 and the measurement distance (Step S3).

In a case where it is determined based on the predicted distance and the reverberation curve RBC specified in advance that the predicted distance of the obstacle OB is within the reverberation period, the detection condition control unit 104 modifies the detection condition (threshold TH) to the threshold TH1 exceeding the reverberation curve RBC (Step S4). At this time, the threshold TH1 may be a value obtained by adding, for example, a predetermined margin to the intensity value of the reverberation at the predicted distance of the obstacle OB.

When the reception waveform RW is acquired next time, the feature amount detection unit 101 detects the feature amount of the reflected wave RW1 based on a new detection condition, and calculates the measurement distance based on the feature amount of the reflected wave RW1 (Step S5). In this manner, the output control unit 105 outputs a new measurement distance (Step S6).

As described above, the distance measurement device 100 adjusts the detection condition of the reflected wave RW1 in a case where it is determined based on the predicted distance that the position of the obstacle OB is a position affected by reverberation. For example, the distance measurement device 100 detects the reflected wave RW1 based on the threshold TH1 exceeding the reverberation curve RBC.

As a result, the distance measurement device 100 can calculate the distance to the obstacle OB even in a case where the obstacle OB is positioned at a position affected by the reverberation. Since the reverberation curve RBC can be specified before the obstacle is detected, the threshold TH1 can be specified before the obstacle is detected. That is, Step S4 may be performed only at the first time after the start of the distance measurement device 100, and the set detection condition does not have to be changed thereafter. As described above, in a case where the threshold TH1 as the detection condition is determined before performing a series of detection and is not changed, it can be said that the detection condition is statically controlled.

Note that the processing in Step S4 may be performed only at the first time the predicted distance of the obstacle OB is within the reverberation period and may be skipped from the second time, or may be performed every time while the predicted distance of the obstacle OB is within the reverberation period. In these cases, since the detection condition is changed according to each reverberation curve at each time that a series of detection is performed, it can be said that the detection condition is dynamically controlled.

### Third Embodiment

In a third embodiment, an example in which a distance measurement device 100 dynamically changes a threshold for detecting the reflected wave RW1 based on an intensity of the reflected wave RW1 in a case where a position of the obstacle OB is a position affected by the reverberation based on the predicted distance will be described.

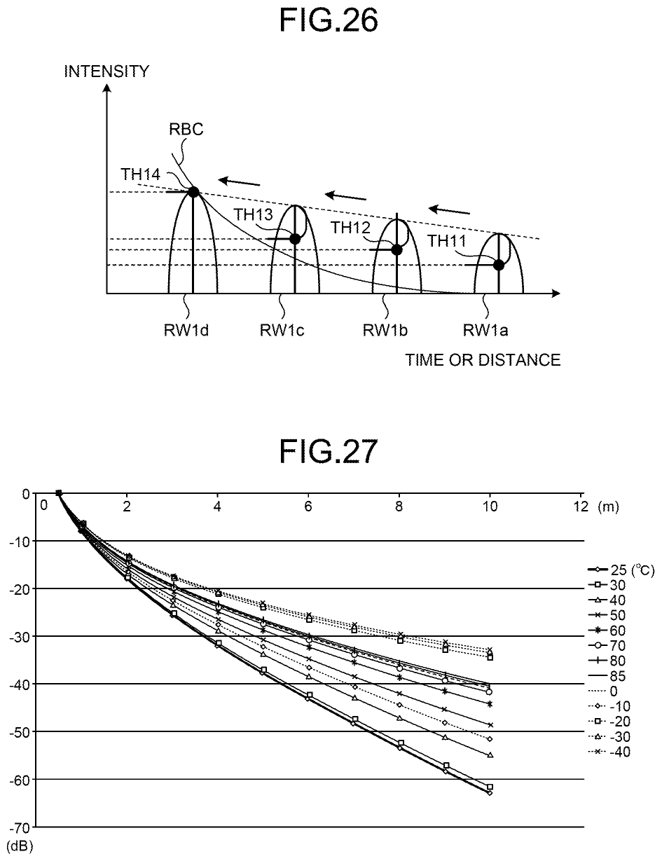

Here, an example of dynamically changing the threshold will be described with reference to FIG. 26. In a case where the distance measurement device 100 determines, based on the predicted distance, that the position of the obstacle OB is a position affected by the reverberation, a detection condition control unit 104 changes the threshold for detecting the reflected wave RW1 based on the intensity of the reflected wave RW1.

For example, as illustrated in FIG. 26, the detection condition control unit 104 sets the threshold to be higher as the reflected wave RW1 approaches. That is, the detection condition control unit 104 sets a threshold TH12 for a position of the reflected wave RW1b to be higher than a threshold TH11 for a position of the reflected wave RW1a. As described above, since the distance measurement device 100 dynamically increases the threshold, the distance can be calculated even at a position near the sonar 10 where the degree of influence of the reverberation increases.

Specifically, the detection condition control unit 104 may dynamically change the threshold based on a change in peak value of the reflected wave RW1. In FIG. 26, a predicted value of an intensity value of a peak of the reflected wave RW1b at the next predicted distance is obtained based on an intensity value of a peak of the reflected wave RW1a, and a value obtained by subtracting a predetermined value from an intensity value of a peak at the next predicted distance is set as the threshold TH12 in the next detection.

The setting of the threshold is dynamically repeated in a manner that the next predicted distance is calculated at a time point at which the reflected wave RW1b is received, a predicted value of an intensity value of a peak of the reflected wave RW1c at the next predicted distance is obtained, and a threshold TH13 in the next detection is obtained. Note that the detection condition control unit 104 may predict the change in peak value of the reflected wave RW1b based on an air attenuation rate.

Here, FIG. 27 illustrates an example of an air attenuation curve. FIG. 27 is a diagram illustrating an example of the air attenuation curve for each temperature. In the graph of FIG. 27, the vertical axis represents the intensity of the reception signal, and the horizontal axis represents the distance. The graph illustrates that the intensity of the reception signal decreases as the distance increases at any temperature. In addition, FIG. 27 illustrates that the intensity of the reception signal is affected by the temperature, and illustrates that the degree of decrease in intensity of the reception signal is lower at a lower temperature.

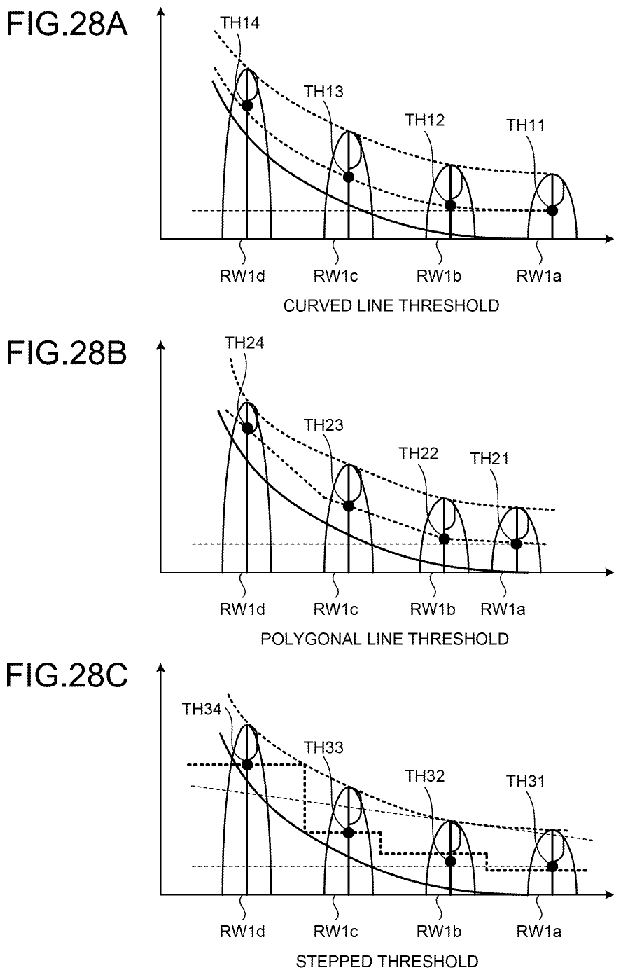

Subsequently, FIGS. 28A to 28C illustrate examples of a form of the threshold. For example, as illustrated in FIG. 28A, thresholds TH11 to TH14 may form a curved line shape, or as illustrated in FIG. 28B, thresholds TH21 to TH24 may form a polygonal line shape. In addition, as illustrated in FIG. 28C, thresholds TH31 to TH34 may form a stepped shape.

As described above, the threshold TH may be dynamically updated every time the reflected wave is received. Alternatively, as a compromise method, a predicted value of the reception intensity at each distance may be obtained as a predicted reception intensity curve based on the reception intensity of the reflected wave RW1a and the air attenuation curve, and the thresholds forming the curved line shape as illustrated in FIG. 28A may be set based on the predicted reception intensity curve. The set thresholds may be updated every time the reflected wave RW1b or the reflected wave RW1c is received, or the thresholds may be maintained on condition that the reflected wave changes according to the prediction.

Furthermore, the detection condition control unit 104 may further set the threshold in such a manner that the threshold is above the reverberation curve RBC. That is, when setting the thresholds illustrated in FIGS. 28A to 28C, the condition that the threshold is above the reverberation curve RBC may be applied. For example, in a case where the threshold set according to the predicted reception intensity curve is below the reverberation curve RBC in some sections, the threshold of the section may be corrected to be above the reverberation curve RBC.

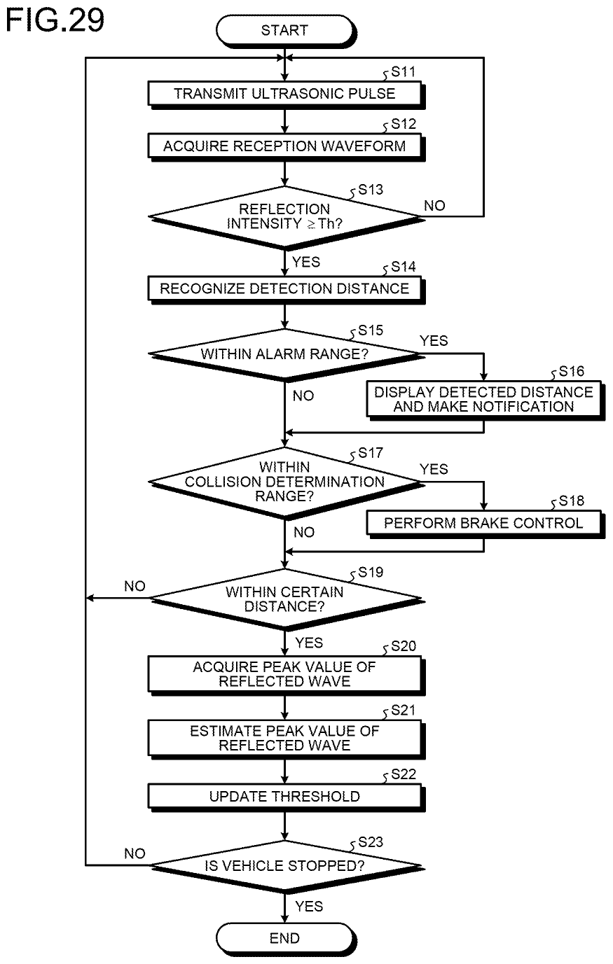

Next, a processing procedure in which the distance measurement device 100 according to the third embodiment measures the distance will be described with reference to FIG. 29.

First, the sonar 10 transmits an ultrasonic wave (Step S11). A feature amount detection unit 101 acquires the reception waveform RW (Step S12). In a case where a signal intensity of the reflected wave is equal to or greater than the threshold (Step S13: Yes), the feature amount detection unit 101 detects the feature amount of the reflected wave RW1, and a measurement distance calculation unit 102 calculates the distance based on a position of the reflected wave RW1 (Step S14).

In a case where it is determined that the calculated distance is within an alarm range (Step S15: Yes), the ECU 20 causes the notification unit 30 to perform display and sound output based on an alarm (Step S16). In a case where it is determined that the calculated distance is within a collision determination range (Step S17: Yes), the ECU 20 causes the drive control unit 40 to perform a brake operation (Step S18).

In a case where the distance belongs to a reverberation influence range (Step S19: Yes), the detection condition control unit 104 acquires a peak value of the reflected wave RW1 (Step S20). Subsequently, the detection condition control unit 104 estimates a peak value of the reflected wave RW1 in the next reception (Step S21).

For example, the detection condition control unit 104 may estimate the peak value of the reflected wave RW1 in the next reception based on the degree of increase in peak value of the past reflected wave RW1. That is, the detection condition control unit 104 may store in advance information in which the distance and the signal intensity of the reflected wave RW1 are associated with each other, and estimate the peak value of the reflected wave RW1 in the next reception based on the information (Step S21). Alternatively, the detection condition control unit 104 may estimate the peak value of the reflected wave RW1 at the predicted distance from the peak value of the reflected wave RW1, the air attenuation curve, and the temperature information.

The detection condition control unit 104 updates the threshold based on the estimated peak value of the reflected wave RW1 (Step S22). Since such a threshold control is repeated while the vehicle is traveling, in a case where the vehicle 1 is not stopped (Step S23: No), the processing proceeds to Step S11. In this case, in Step S13, the feature amount detection unit 101 detects the feature amount by using a new threshold.

As described above, since the distance measurement device 100 dynamically changes the threshold for detecting the feature amount based on the change in feature amount in a case where the reflected wave arrives during the reverberation period, the distance to the obstacle OB can be calculated even in a case where the obstacle OB is positioned at a position affected by the reverberation.

A program executed by the distance measurement device 100 of the present embodiment is provided by being incorporated in a ROM or the like in advance.

The program executed by the distance measurement device 100 of the present embodiment may be a file in an installable format or an executable format, and may be provided by being recorded on a computer-readable recording medium such as a CD-ROM, a flexible disk (FD), a CD-R, or a digital versatile disk (DVD).

Further, the program executed by the distance measurement device 100 of the present embodiment may be stored on a computer connected to a network such as the Internet and be provided by being downloaded via the network. Further, the program executed by the distance measurement device of the present embodiment may be provided or distributed via a network such as the Internet.

With the distance measurement device according to the present disclosure, it is possible to more appropriately measure a distance even in a range affected by reverberation.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A distance measurement device mountable on a vehicle, comprising:
a transmission and reception device configured to transmit a transmission wave that is an ultrasonic wave and receive a reflected wave generated by the transmission wave;
a memory; and
a hardware processor coupled to the memory, the hardware processor being configured to:
detect a reception signal received by the transmission and reception device and obtain a reception waveform indicating a temporal change in an intensity of the reception signal;
detect a feature amount of the reflected wave based on the reception waveform;
calculate a distance from the distance measurement device to an object as a measurement distance, based on the feature amount; and
control a detection condition of detection of the feature amount, wherein
the hardware processor is configured to adjust the detection condition by changing a threshold for detecting the feature amount, based on a change in the feature amount, in a case where the reflected wave arrives during a reverberation period in which reverberation of the transmission wave remains in the transmission and reception device.

2. The distance measurement device according to claim 1, wherein
the detection condition includes at least one of: an intensity of the transmission wave; an amplification degree of the reception signal; and a detection threshold for detecting the feature amount from the reception waveform, and
the hardware processor is configured to perform either of: static detection condition adjustment of adjusting the detection condition in advance in such a manner that the feature amount of the reflected wave is detectable from the reception waveform even in a case where the reflected wave arrives during the reverberation period; and dynamic detection condition adjustment of changing the detection condition in such a manner that the feature amount of the reflected wave is detectable from the reception waveform in a case where the reflected wave arrives during the reverberation period.

3. The distance measurement device according to claim 1, wherein the hardware processor is configured to estimate a predicted intensity of the reflected wave, based on the feature amount of the reflected wave, and adjust the detection condition, based on the predicted intensity.

4. The distance measurement device according to claim 1, wherein the hardware processor is configured to change the threshold for detecting the feature amount, further based on a reverberation curve stored in advance or a reverberation curve specified from the reception waveform.

5. The distance measurement device according to claim 4, wherein the hardware processor is configured to acquire characteristic information of the transmission and reception device, and correct the reverberation curve, based on the characteristic information of the transmission and reception device.

6. The distance measurement device according to claim 4, wherein the hardware processor is configured to change the threshold for detecting the feature amount, further based on an attenuation curve of the reception waveform.

7. The distance measurement device according to claim 4, wherein
the hardware processor is further to estimate a rising position of the reflected wave, and
the hardware processor is configured to estimate the rising position of the reflected wave, based on a straight line defining a maximum value of an amplitude of the reflected wave and a value of an amplitude of the reflected wave that has exceeded a first threshold for a first time in the reception waveform, in a case where an intersection point indicating a point where the reverberation curve and the reception waveform intersect each other is below the first threshold, the first threshold indicating a detection threshold of a reception intensity detectable by the ultrasonic wave.

8. The distance measurement device according to claim 7, wherein the hardware processor is configured to estimate the rising position based on a straight line defining the maximum value and the intersection point, in a case where the intersection point is equal to or greater than the first threshold.

9. The distance measurement device according to claim 7, wherein the hardware processor is configured to estimate the rising position based on the maximum value and a transmission pulse length indicating a duration of a pulse of the transmission wave transmitted by the ultrasonic wave, in a case where the maximum value is less than a second threshold indicating a threshold of a reflection intensity of reflection by the reflected wave or in a case where the reflected wave acquired by the transmission and reception device is not present during the reverberation period indicated by the reverberation curve.

10. The distance measurement device according to claim 7, wherein
the hardware processor is further configured to:
calculate a predicted distance obtained by predicting, based on the measurement distance, a measurement distance in a next measurement; and
output one of the measurement distance or the predicted distance as an output value, and
the hardware processor is configured to output the predicted distance as the output value instead of the measurement distance, in a case where a predicted distance output condition for outputting the predicted distance as the output value is satisfied.

11. The distance measurement device according to claim 10, wherein the hardware processor is configured to further acquire the predicted distance, estimate the predicted intensity of the reflected wave, based on the feature amount of the reflected wave and the predicted distance, and adjust the detection condition based on the predicted intensity.

12. The distance measurement device according to claim 10, wherein the hardware processor is configured to determine that the predicted distance output condition is satisfied in any of following cases: a case where the detection condition is uncontrollable by the detection condition control device in such a manner that the feature amount of the reflected wave at the predicted distance is detectable; a case where the feature amount of the reflected wave is undetectable from the reception waveform; and a case where the feature amount of the reflected wave does not satisfy a predetermined condition.

13. The distance measurement device according to claim 10, wherein
the feature amount includes intensity values of any two points of: the intersection point between the reception waveform and the reverberation curve; an intersection point between the reception waveform and the detection threshold; and an intersection point between the reception waveform and a saturation value, and
it is determined that a case where a difference between the intensity values of the two points does not exceed a predetermined threshold, a case where there is no intersection point between the reception waveform and the reverberation curve, or a case where there is no intersection point between the reception waveform and the detection threshold corresponds to the case where the feature amount of the reflected wave does not satisfy the predetermined condition.

14. The distance measurement device according to claim 10, wherein the hardware processor is configured to determine that a case where the reverberation curve exceeds a saturation value at the predicted distance or a case where the reverberation curve exceeds the detection threshold at the predicted distance corresponds to the case where the detection condition is uncontrollable in such a manner that the feature amount of the reflected wave at the predicted distance is detectable.

15. The distance measurement device according to claim 13, wherein the hardware processor is configured to acquire information on at least one intersection point of three points including: the intersection point between the reception waveform and the reverberation curve; the intersection point between the reception waveform and the detection threshold; and the intersection point between the reception waveform and the saturation value, and the hardware processor is configured to adjust the detection condition according to the information on the at least one intersection point.

16. The distance measurement device according to claim 15, wherein the hardware processor is configured to further acquire the predicted distance, estimate a predicted value of information on the intersection point based on the information on the at least one intersection point and the predicted distance, and adjust the detection condition according to the predicted value of the information on the intersection point.
